(19) United States
(12) Patent Application Publication
(10) Pub. No.: US 2026/0161113 A1
(43) Pub. Date: Jun. 11, 2026

(54) IMAGE FORMING APPARATUS

(71) Applicant: CANON KABUSHIKI KAISHA, Tokyo (JP)

(72) Inventor: YASUHIRO SENDOUDA, Shizuoka (JP)

(21) Appl. No.: 19/179,392

(22) Filed: Apr. 15, 2025

(30) Foreign Application Priority Data
Apr. 26, 2024 (JP) 2024-073086

(51) Int. Cl. G03G 15/08; G03G 21/16

(52) U.S. Cl. CPC G03G 15/0863; G03G 15/0875; G03G 15/0877; G03G 21/1676; G03G 2215/068; G03G 2215/0695; G03G 2221/163

(57) ABSTRACT

An image forming apparatus includes a toner cartridge including a toner storage portion, a discharge opening, and an information holding portion, a rotary including a developing roller, a developing-side storage portion, and an attached portion, and a reading portion configured to read information from the information holding portion. The discharge opening faces up in a vertical direction when the toner cartridge is attached to the attached portion of the rotary in the replacement posture. Toner starts to flow into the developing-side storage portion from the toner cartridge when the rotary is rotated beyond a first angle in a predetermined direction from the replacement posture. In a case where the toner cartridge is attached to the attached portion, the reading portion is configured to read the information from the information holding portion before the rotary is rotated beyond the first angle in the predetermined direction from the replacement posture.

### BACKGROUND OF THE INVENTION

### Field of the Invention

The present invention relates to an image forming apparatus that forms an image on a recording medium.

### Description of the Related Art

Japanese Patent Application Laid-Open No. 2008-096852 discloses an image forming apparatus of a rotary development system that forms a color image by rotating a rotary including a plurality of developing rollers. Japanese Patent Application Laid-Open No. 2007-183305 discloses an image forming apparatus of a rotary development system in which four toner cartridges each storing toner of a different color are attachable to and detachable from a rotary.

When the rotary is rotated in a state in which a toner cartridge of a type different from a type that is supposed to be attached is attached to an attached portion of the rotary, there is a possibility that a wrong type of toner is mixed with toner stored in a storage portion in the rotary. Therefore, it is preferable that the type of the toner cartridge is identified in a state in which toner has not flowed into the storage portion in the rotary from the toner cartridge attached to the attached portion.

### SUMMARY OF THE INVENTION

The present invention provides an image forming apparatus having a configuration in which a type of a toner cartridge can be identified in a state in which toner has not flowed into a storage portion in a rotary from the toner cartridge attached to an attached portion.

According to an aspect of the invention, an image forming apparatus includes a toner cartridge including a toner storage portion configured to store toner, a discharge opening communicating with the toner storage portion, and an information holding portion, a rotary including a developing roller, a developing-side storage portion configured to store toner to be supplied to the developing roller, and an attached portion to which the toner cartridge is attached, the rotary being configured to take a replacement posture in which attachment and detachment of the toner cartridge to and from the attached portion are allowed, and a reading portion configured to read information from the information holding portion, wherein the discharge opening faces up in a vertical direction when the toner cartridge is attached to the attached portion of the rotary in the replacement posture, wherein toner starts to flow into the developing-side storage portion from the toner cartridge when the rotary is rotated beyond a first angle in a predetermined direction from the replacement posture, and wherein in a case where the toner cartridge is attached to the attached portion, the reading portion is configured to read the information from the information holding portion before the rotary is rotated beyond the first angle in the predetermined direction from the replacement posture.

According to another aspect of the invention, an image forming apparatus includes a toner cartridge including a toner storage portion configured to store toner, a discharge opening communicating with the toner storage portion, and an information holding portion, a rotary including a developing roller, a developing-side storage portion configured to store toner to be supplied to the developing roller, and an attached portion to which the toner cartridge is attached, the rotary being configured to take a replacement posture in which attachment and detachment of the toner cartridge to and from the attached portion are allowed, and a reading portion configured to read information from the information holding portion, wherein the discharge opening faces up in a vertical direction when the toner cartridge is attached to the attached portion of the rotary in the replacement posture, wherein the developing-side storage portion includes an inlet opening to receive toner from the toner cartridge and is configured such that an opening direction of the inlet opening is horizontal in a case where the rotary is rotated to a first angle in a predetermined direction from the replacement posture, and wherein in a case where the toner cartridge is attached to the attached portion, the reading portion is configured to read the information from the information holding portion before the rotary is rotated beyond the first angle in the predetermined direction from the replacement posture.

Further features of the present invention will become apparent from the following description of exemplary embodiments with reference to the attached drawings.

### BRIEF DESCRIPTION OF THE DRAWINGS

FIG. 1 is a schematic diagram illustrating arrangement of a reading unit according to a first embodiment.

FIG. 2 is a schematic view of an image forming apparatus according to the first embodiment.

FIG. 3A is a schematic view of a rotary body and one of toner cartridges according to the first embodiment.

FIGS. 3B to 3E are explanatory diagrams of the rotational angle of the rotary body.

FIGS. 4A and 4B are each a section view of the image forming apparatus according to the first embodiment.

FIG. 5 is a perspective view of a rotary body according to the first embodiment.

FIGS. 6A to 6C are each a perspective view of the image forming apparatus according to the first embodiment.

FIGS. 7A and 7B are each a section view of the image forming apparatus according to the first embodiment.

FIG. 8 is an explanatory diagram of the rotary body according to the first embodiment.

FIG. 9 is an explanatory diagram of the rotary body according to the first embodiment.

FIGS. 10A and 10B are each an explanatory diagram of elements related to movement of a tray according to the first embodiment.

FIGS. 11A and 11B are each an explanatory diagram of elements related to movement of the tray according to the first embodiment.

FIG. 12 is a perspective view of the rotary body, the toner cartridge, and the reading unit according to the first embodiment.

FIG. 13 is a perspective view of the toner cartridge.

FIG. 14A is a block diagram illustrating a control system of the image forming apparatus according to the first embodiment.

FIG. 14B is a schematic diagram illustrating elements related to movement of the tray.

FIG. 15 is a flowchart illustrating a control method of the image forming apparatus according to the first embodiment.

FIG. 16 is a schematic diagram illustrating arrangement of the reading unit according to a modification example.

FIG. 17 is a perspective view of a toner cartridge according to a second embodiment.

FIG. 18 is a perspective view a toner cartridge according to a third embodiment.

### DESCRIPTION OF THE EMBODIMENTS

Embodiments of the present disclosure will be described below with reference to drawings.

### First Embodiment

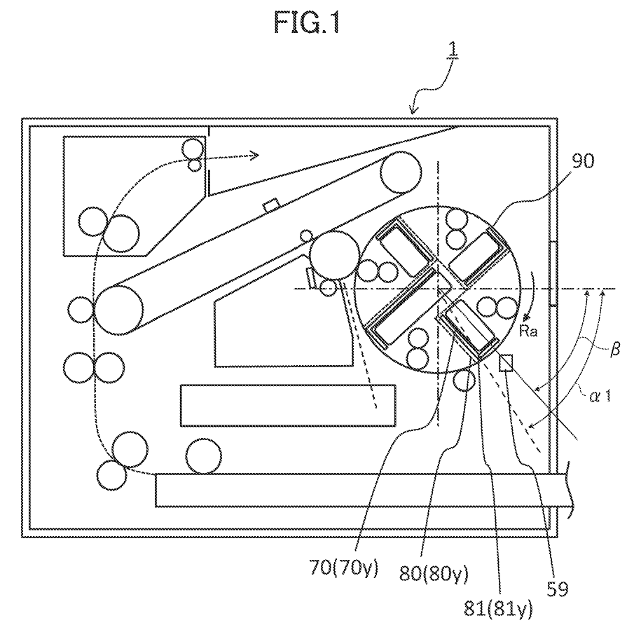

An image forming apparatus 1 according to a first embodiment will be described with reference to FIGS. 1 to 15. In the description below and each drawing, the vertical direction in the case where the image forming apparatus 1 is disposed on a horizontal surface will be referred to as a Z direction. A direction that intersects with the Z direction and that is the direction of a rotational axis 90C of a rotary body 90 (rotational axis direction of a rotary) that will be described later will be referred to as a Y direction. A direction intersecting with both the Z direction and the Y direction will be referred to as an X direction. The X direction and the Y direction are preferably horizontal directions. In addition, the X direction, the Y direction, and the Z direction are preferably orthogonal to each other. In addition, the sides pointed by arrows X, Y, and Z illustrated in each diagram will be respectively referred to as +X, +Y, and +Z sides, and sides opposite thereto will be respectively referred to as -X, -Y, and -Z sides.

### Overall Configuration of Image Forming Apparatus

First, an overall configuration of the image forming apparatus 1 will be described. The image forming apparatus 1 is a laser beam printer that forms an image on a sheet S by using an electrophotographic method. Specifically, the image forming apparatus 1 is a color laser beam printer including four developing units 50y, 50m, 50c, and 50k. As the sheet S serving as a recording material (recording medium), various sheet materials of different sizes and different materials can be used. Examples of the various sheet materials include paper sheets such as plain paper sheets and cardboards, plastic films, cloths, surface-treated sheet materials such as coated paper sheets, and sheet materials of irregular shapes such as envelopes and index paper sheets.

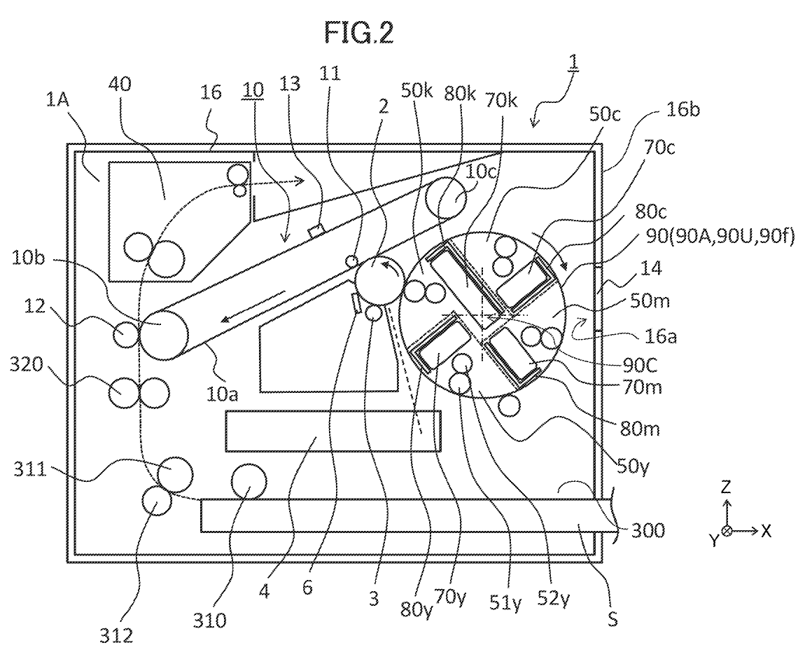

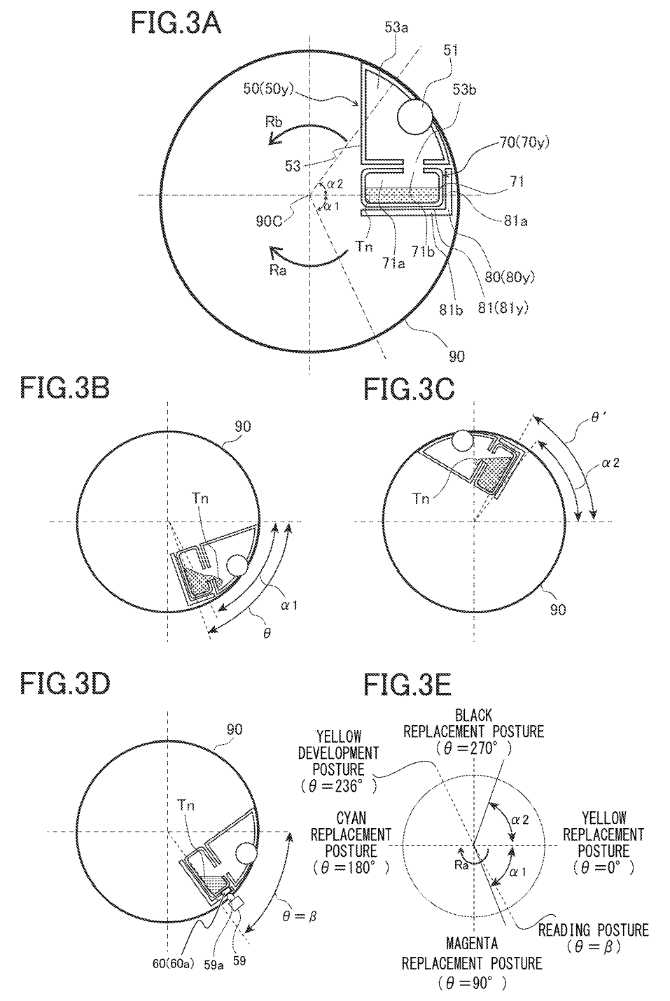

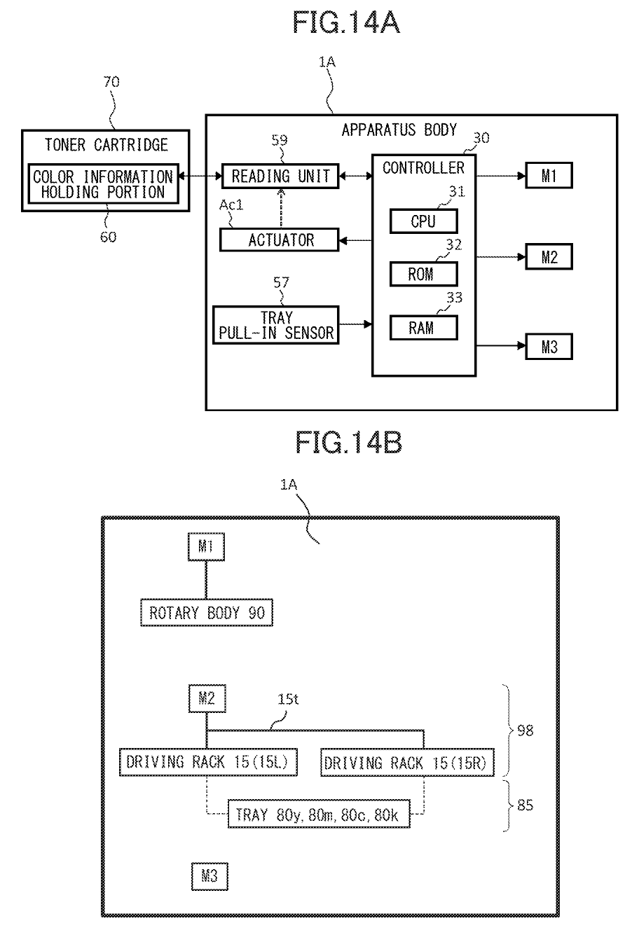

A schematic configuration of the image forming apparatus 1 and an image forming operation will be described with reference to FIGS. 2, 3A, 14A, and 14B. FIG. 2 is a schematic diagram illustrating a sectional configuration of the image forming apparatus 1. FIG. 3A is a concept diagram illustrating elements for supplying toner from a toner cartridge 70 to a developing unit 50. FIG. 14A is a block diagram illustrating a control system of the image forming apparatus 1. FIG. 14B is a diagram illustrating a driving configuration of the tray 80.

As illustrated in FIG. 2, the image forming apparatus 1 includes an image forming apparatus main body (hereinafter referred to as an apparatus body 1A), and toner cartridges 70y, 70m, 70c, and 70k that are attachable to and detachable from the apparatus body 1A. The apparatus body 1A of the present embodiment is a part of the image forming apparatus 1 excluding the toner cartridges 70y, 70m, 70c, and 70k.

The apparatus body 1A of the image forming apparatus 1 includes a photosensitive member 2 for use in an electrophotographic system. The photosensitive member has a drum shape (cylindrical shape) and is hereinafter referred to as a photosensitive drum 2. The photosensitive member 2 serves as an image bearing member that bears an electrostatic latent image. A charging roller 3, a scanner 4 serving as an exposing device, and a cleaning unit 6 are disposed around the photosensitive drum 2.

The charging roller 3 is an example of a charging portion or a charging unit for uniformly charging the photosensitive drum 2. The scanner 4 is an example of an exposing portion or an exposing unit that exposes the photosensitive drum 2 by irradiating the photosensitive drum 2 with laser light in accordance with image information. By irradiating the photosensitive drum 2 with the laser light after charging, an electrostatic latent image is formed on each surface of the photosensitive drum 2. The cleaning unit 6 is an example of a cleaning portion that removes toner remaining on the surface of the photosensitive drum 2.

Further, the apparatus body 1A includes a sheet storage portion 300, a pickup roller 310, a feed roller 311, a separation roller 312, a conveyance roller pair 320, a secondary transfer roller 12, a fixing device 40, and an intermediate transfer unit 10. The pickup roller 310 is an example of a feeding portion or a feeding unit that feeds the sheet S. The feed roller 311 and the separation roller 312 are an example of a separation conveyance unit that conveys sheets S while separating the sheets S from each other by frictional force. The secondary transfer roller 12 is an example of a transfer portion or a transfer unit that transfers an image from an intermediate transfer belt 10a onto the sheet S.

The intermediate transfer unit 10 includes an intermediate transfer belt 10a, a belt driving roller 10b, a tension roller 10c, a cleaning device 13, and a primary transfer roller 11. The intermediate transfer belt 10a is an example of an intermediate transfer member that bears an image transferred from the photosensitive drum 2 through primary transfer and conveys the image so as to transfer the image onto the sheet S through secondary transfer. The intermediate transfer belt 10a is stretched over the belt driving roller 10b and the tension roller 10c. The belt driving roller 10b is a driving member that is rotationally driven by a drive source to convey the intermediate transfer belt 10a.

In addition, the apparatus body 1A includes a rotary body 90, which serves as a rotary, rotator, or developing device, including the developing units 50y, 50m, 50c, and 50k. As will be described later, trays 80y, 80m, 80c, and 80k, which serve as support members, are attached to the rotary body 90 in the present embodiment. Toner cartridges 70y, 70m, 70c, and 70k are detachably attached to the trays 80y, 80m, 80c, and 80k.

In the description below, a plurality of members having similar functions can be distinguished by numbers given thereto. For example, one of the toner cartridges 70y, 70m, 70c, and 70k may be referred to as a first toner cartridge, one of the remaining three may be referred to as a second toner cartridge, one of the remaining two may be referred to as a third toner cartridge, and the last one may be referred to as a fourth toner cartridge. Similarly, one of the trays 80y, 80m, 80c, and 80k may be referred to as a first tray, one of the remaining three may be referred to as a second tray, one of the remaining two may be referred to as a third tray, and the last one may be referred to as a fourth tray. That is, one of the trays 80y to 80k is an example of a first support member, another one of the trays 80y to 80k is an example of a second support member, yet another one of the trays 80y to 80k is an example of a third support member, and the last one of the trays 80y to 80k is an example of a fourth support member. This numbering is merely used for the sake of convenience of description, and can be interchanged appropriately in principle.

The developing units 50y, 50m, 50c, and 50k serving as first to fourth developing units are examples of developing units or developing portions that each develop (visualize) an electrostatic latent image formed on the photosensitive drum 2 into a toner image by using toner of a corresponding color. The developing units 50y, 50m, 50c, and 50k each develop the electrostatic latent image formed on the photosensitive drum 2 by using corresponding one of yellow toner, magenta toner, cyan toner, and black toner. The developing units 50y, 50m, 50c, and 50k may be arranged in an order different from the order illustrated in FIG. 2.

The developing unit 50y includes a developing roller 51y, a supply roller 52y, and a developing blade. The developing roller 51y is a developer bearing member that rotates while bearing toner serving as developer or developing agent, and supplies the toner to the photosensitive drum 2. The supply roller 52y is a supply member that is disposed in contact with the developing roller 51y and supplies toner to the developing roller 51y. The developing blade is a regulation member that regulates the thickness of a toner layer borne on the developing roller 51y. The other developing units 50m, 50c, and 50k respectively include developing rollers 51m, 51c, and 51k, supply rollers 52m, 52c, and 52k, and developing blades that are configured in a similar manner.

The toner cartridges 70y, 70m, 70c, and 70k corresponding to the developing units 50y, 50m, 50c, and 50k are attached to the rotary body 90. The toner cartridges 70y, 70m, 70c, and 70k respectively store therein yellow toner, magenta toner, cyan toner, and black tonner to be supplied to the developing units 50y, 50m, 50c, and 50k. One of the toners of four colors may be referred to as first toner, one of the toners of remaining three colors may be referred to as second toner, one of the toners of remaining two colors may be referred to as third toner, and the toner of the last remaining color may be referred to as fourth toner. For example, the black toner may be referred to as an example of first toner, and the magenta toner may be referred to as an example of second toner. This numbering is merely used for the sake of convenience of description, and can be interchanged appropriately in principle.

Here, the rotary body 90 includes a rotary frame 90f supporting the developing units 50y, 50m, 50c, and 50k. The developing units 50y, 50m, 50c, and 50k are supported by the rotary frame 90f that is a rotary support member that is rotatable.

In addition, the trays 80y, 80m, 80c, and 80k are attached to the rotary body 90. The rotary body 90 and the trays 80y, 80m, 80c, and 80k as a combination can be referred to as a rotary unit 90U. In other words, the rotary unit 90U includes the rotary body 90 and the trays 80y, 80m, 80c, and 80k.

The toner cartridges 70y to 70k are detachably held by the trays 80y to 80k. As will be described later, the trays 80y to 80k are supported so as to be slidable to the outside of the rotary body 90. The rotary unit 90U and the toner cartridges 70y, 70m, 70c, and 70k as combined can be referred to as a rotary assembly 90A. In other words, the rotary assembly 90A includes the rotary unit 90U and toner cartridges 70y, 70m, 70c, and 70k.

As will be described later, the rotary body 90 is rotatable about a rotational axis (rotational center) 90C. The rotational axis 90C coincides with a rotational axis of the rotary frame 90f, that of the rotary unit 90U, and that of the rotary assembly 90A. In addition, the rotational axis 90C is substantially parallel to the rotational axis (rotational center) of the photosensitive drum 2.

The rotary body 90 rotates about the rotational axis 90C, and thus can take developing postures in each of which any one of the developing rollers 51y, 51m, 51c, and 51k faces the photosensitive drum 2. A posture in which the developing roller 51y faces the photosensitive drum 2 will be referred to as a yellow developing posture. A posture in which the developing roller 51m faces the photosensitive drum 2 will be referred to as a magenta developing posture. A posture in which the developing roller 51c faces the photosensitive drum 2 will be referred to as a cyan developing posture. A posture in which the developing roller 51k faces the photosensitive drum 2 will be referred to as a black developing posture. That is, the rotary body 90 can rotate about the rotational axis 90C such that the positions of the developing rollers 51y, 51m, 51c, and 51k change with respect to the photosensitive drum 2. The black developing posture is an example of a first developing posture in which the first developing roller (e.g., developing roller 51k) faces the photosensitive drum 2. The other developing postures are examples of a second developing posture in which a second developing roller (e.g., one of the developing rollers 51y to 51c) faces the photosensitive drum 2. The yellow/magenta/cyan/black developing postures can be referred to as first to fourth developing postures. This numbering is merely used for the sake of convenience of description, and can be interchanged appropriately in principle.

As illustrated in FIG. 14A, the apparatus body 1A includes a controller 30, motors M1, M2, and M3 serving as drive sources, a reading unit 59, an actuator Ac1, and a tray pull-in sensor 57. The controller 30 is a control unit (controller) that controls the operation of the image forming apparatus 1 in accordance with a program. The controller 30 includes a read-only memory (ROM) 32 that stores the program, a central processing unit (CPU) 31 that reads out the program from the ROM 32 and executes the program, and a random access memory (RAM) 33 that provides a work area for execution of the program. The reading unit 59, the actuator Ac1, and the tray pull-in sensor 57 will be described later.

The motor M1 supplies a driving force for rotating the rotary body 90 about the rotational axis 90C. In other words, the motor M1 rotates the rotary assembly 90A and the rotary unit 90U about the rotational axis 90C.

In addition, as illustrated in FIG. 14B, the apparatus body 1A includes a driving device 98 including the motor M2 and a transmission device. The transmission device includes driving racks 15L and 15R serving as driving gears and a transmission portion 15t that will be described later. The driving force of the motor M2 is transmitted to the driving racks 15L and 15R by the transmission portion 15t. In other words, the motor M2 is configured to drive the driving racks 15L and 15R, and moves the trays 80y, 80m, 80c, and 80k with respect to the rotary body 90 via the driving racks 15L and 15R.

The motor M3 drives members that are not driven by the motors M1 and M2. For example, the motor M3 drives the photosensitive drum 2, the developing units 50y, 50m, 50c, and 50k, the pickup roller 310, the feed roller 311, the conveyance roller pair 320, the secondary transfer roller 12, the belt driving roller 10b, and the fixing device 40.

To be noted, the members driven by the motors M1, M2, and M3 can be appropriately changed. In addition, the roles of two or three of the motors M1, M2, and M3 can be concentrated in one motor. In addition, a drive source other than the motors M1, M2, and M3 may be added.

Here, the suffices y, m, c, and k given to the developing units 50y, 50m, 50c, and 50k, the toner cartridges 70y, 70m, 70c, and 70k, the trays 80y, 80m, 80c, and 80k, and the like indicate the colors of toner. The developing units 50y, 50m, 50c, and 50k basically have the same configuration and function. The toner cartridges 70y, 70m, 70c, and 70k basically have the same configuration and function. In addition, the trays 80y, 80m, 80c, and 80k basically have the same configuration and function. Therefore, in the case where these do not need to be distinguished, the suffices y, m, c, and k will be omitted, and arbitrarily selected one of the four units, four cartridges, and four trays will be described.

As illustrated in FIG. 3A, the toner cartridge 70 includes a toner frame 71. The toner frame 71 includes a toner storage portion 71a that stores toner, and a discharge opening (discharge port) 71b communicating with the toner storage portion 71a.

The developing unit 50 includes a developing frame 53 serving as a storage frame. The developing frame 53 includes a developing-side storage portion 53a and an inlet opening (receiving opening) 53b communicating with the developing-side storage portion (toner supply chamber) 53a. To be noted, as described above, although the developing unit 50 includes the supply roller 52 and the like, illustration of these members is omitted in FIG. 3A.

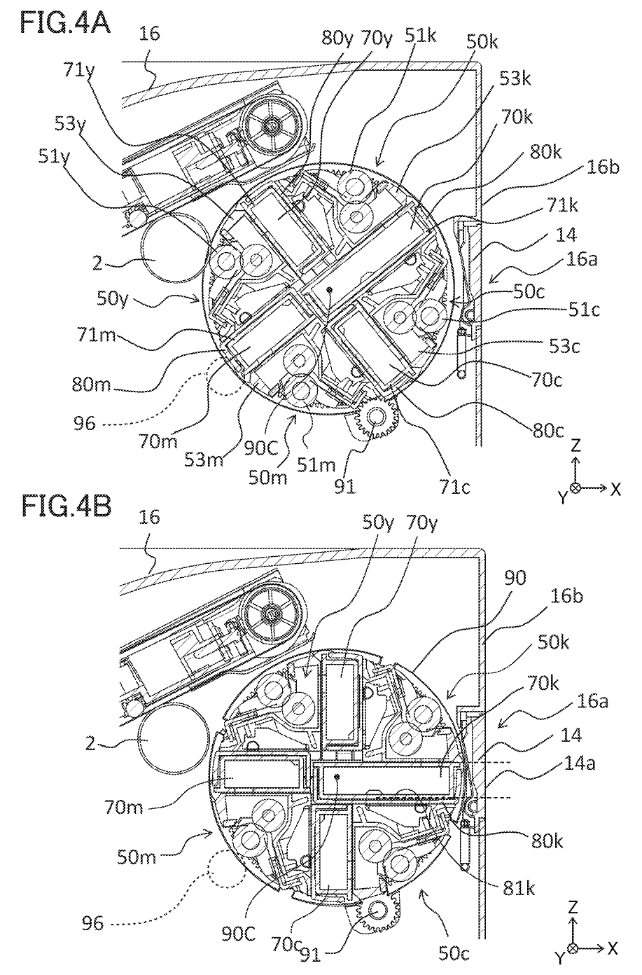

The developing roller 51k included in the developing unit 50k is an example of a first developing roller. The developing roller 51m included in the developing unit 50m is an example of a second developing roller. A developing frame 53k of the developing unit 50k including the developing-side storage portion 53a illustrated in FIG. 4A is an example of a first storage frame including a first storage portion. A developing frame 53m of the developing unit 50m including the developing-side storage portion 53a illustrated in FIG. 4A is an example of a second storage frame including a second storage portion. The rotary body 90 is an example of a rotary that is rotatable and includes a first developing roller, a second developing roller, a first storage frame including a first storage portion, and a second storage frame including a second storage portion. In the present embodiment, the rotary body 90 includes first to fourth developing rollers and first to fourth storage frames.

As will be described later, the toner cartridge 70 is movable to an attached position and a retracted position where the toner cartridge 70 is retracted from the attached position, with respect to the developing frame 53. In a state in which the toner cartridge 70 is at the attached position with respect to the developing frame 53, the discharge opening 71b faces the inlet opening 53b. That is, the toner storage portion 71a of the toner cartridge 70 and the developing-side storage portion 53a of the developing unit 50 communicate with each other via the discharge opening 71b and the inlet opening 53b. When toner is supplied from the toner cartridge 70 to the developing unit 50, at least part of the inlet opening 53b is positioned below at least part of the discharge opening 71b.

Then, toner stored in the toner storage portion 71a is discharged through the discharge opening 71b, and the toner discharged through the discharge opening 71b is stored in the developing-side storage portion 53a through the inlet opening 53b. The toner stored in the developing-side storage portion 53a is supplied to the developing roller 51 by the supply roller 52. The toner stored in the toner storage portion 71a is supplied to the developing roller 51 through such a path.

The toner cartridge 70 preferably includes an unillustrated sealing member (first sealing member) that covers the discharge opening 71b. In addition, the developing unit 50 preferably includes an unillustrated sealing member (second sealing member) that covers the inlet opening 53b.

In a state in which the toner cartridge 70 is not attached to the developing unit 50, the discharge opening 71b and the inlet opening 53b are preferably each covered by a sealing member such that leakage of toner through the discharge opening 71b and the inlet opening 53b is suppressed.

### Image Forming Operation

An image forming operation in the present embodiment will be described. First, the photosensitive drum 2 is rotated in an arrow direction (counterclockwise direction) in FIG. 2 in synchronization with the rotation of the intermediate transfer belt 10a. Further, the surface of the photosensitive drum 2 is uniformly charged by the charging roller 3.

In the case of forming a color image on the sheet S, the rotary body 90 rotates in an arrow direction (clockwise direction) in FIG. 2 while supporting the developing units 50y, 50m, 50c, and 50k. Then, an electrophotographic process is repeatedly performed while moving the developing rollers 51y, 51m, 51c, and 51k to a developing position one by one.

First, the scanner 4 emits laser light based on image data corresponding to a yellow image, and thus forms an electrostatic latent image corresponding to the yellow image on the surface of the photosensitive drum 2. In parallel with the formation of this electrostatic latent image, the motor M1 rotates the rotary body 90, and the rotary body 90 takes the yellow developing posture. When the rotary body 90 is in the yellow developing posture, the developing roller 51y is in the developing position, and the electrostatic latent image formed on the photosensitive drum 2 is developed with yellow toner.

Here, in the present embodiment, the developing rollers 51y, 51m, 51c, and 51k are each an elastic roller formed by covering a metal shaft with rubber. At the developing position, the developing rollers 51y, 51m, 51c, and 51k each develop the electrostatic latent image in a state of being in contact with the photosensitive drum 2. That is, a contact development system is employed for the image forming apparatus 1 of the present embodiment. However, at the developing position, each of the developing rollers 51y, 51m, 51c, and 51k may develop the electrostatic latent image with a gap between the developing roller and the photosensitive drum 2. That is, a non-contact development system may be employed for the image forming apparatus 1.

After the yellow toner image is developed, the yellow toner image on the photosensitive drum 2 is transferred onto the intermediate transfer belt 10a through primary transfer by the primary transfer roller 11 disposed on the inner peripheral side of the intermediate transfer belt 10a.

After this, toner images of respective colors are formed by rotating the rotary body 90 and thus sequentially moving the developing rollers 51m, 51c, and 51k to the developing position. That is, after the yellow toner image is formed on the intermediate transfer belt 10a, the rotary body 90 takes a magenta developing posture, and a magenta toner image is formed on the intermediate transfer belt 10a. After the magenta toner image is formed on the intermediate transfer belt 10a, the rotary body 90 takes a cyan developing posture, and a cyan toner image is formed on the intermediate transfer belt 10a. After the cyan toner image is formed on the intermediate transfer belt 10a, the rotary body 90 takes a black developing posture, and a black toner image is formed on the intermediate transfer belt 10a. After the black toner image is formed on the intermediate transfer belt 10a, the rotary body 90 rotates about the rotational axis 90C in an arrow direction (clockwise direction) illustrated in FIG. 2, and returns to the yellow developing posture. To be noted, the color of the image to be formed first on the intermediate transfer belt 10a can be arbitrarily selected, and for example, the black toner image may be formed first.

Then, primary transfer is repeated so as to superimpose the toner images of four colors on each other on the intermediate transfer belt 10a, and thus a color image is formed on the intermediate transfer belt 10a. To be noted, before the color image is formed on the intermediate transfer belt 10a, the secondary transfer roller 12 and the cleaning device 13 are not in contact with the intermediate transfer belt 10a.

Meanwhile, the sheet S is fed by the pickup roller 310 from the sheet storage portion 300 provided in a lower portion of the apparatus body 1A. The sheet S is conveyed to the conveyance roller pair 320 in a state in which one sheet S is separated from a stack of sheets S by the feed roller 311 and the separation roller 312. The conveyance roller pair 320 delivers out the fed sheet S to a transfer portion (secondary transfer portion) that is a nip portion between the intermediate transfer belt 10a and the secondary transfer roller 12. The color image on the intermediate transfer belt 10a is transferred onto the surface of the conveyed sheet S through secondary transfer.

The sheet S onto which a color image has been transferred is conveyed to the fixing device 40. In the fixing device 40, the sheet S is heated and pressurized, and thus the image is fixed to the sheet S. The sheet S having passed the fixing device 40 is discharged to the outside of the image forming apparatus 1 as a product.

In contrast, in the case of forming a black-and-white image (monochrome image) on the sheet S, the rotary body 90 takes the black developing posture. In this state, an electrostatic latent image is formed on the surface of the photosensitive drum 2 by charging and exposing the photosensitive drum 2, and then the electrostatic latent image is developed with black toner by the developing roller 51k positioned at the developing position. The black toner image is transferred onto the intermediate transfer belt 10a through primary transfer, and then the toner image is transferred onto the sheet S through secondary transfer. Steps after this are similar to the case of a color image.

### Rotary Configuration

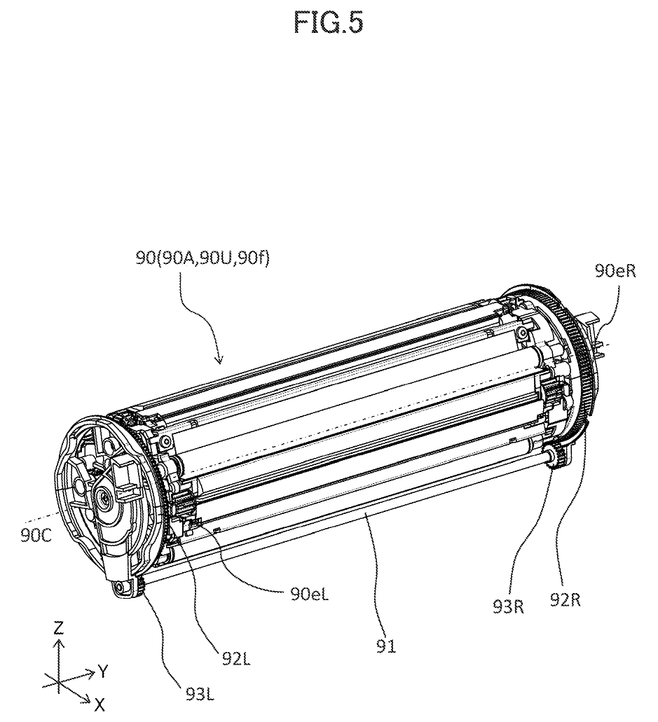

The configuration of the rotary body 90 will be described with reference to FIGS. 2, 4A, 4B, and 5. FIGS. 4A and 4B are each a section view of the rotary body 90 of the image forming apparatus 1 and the surroundings thereof. To be noted, FIGS. 4A and 4B are each a section view taken along a virtual plane orthogonal to the rotational axis 90C of the rotary body 90. FIG. 5 is a perspective view of the rotary body 90.

As has been described, the toner cartridges 70y to 70k are attachable to and detachable from the rotary body 90. In the case where toner in the toner cartridges 70y to 70k has run out, the user can replenish the image forming apparatus 1 with toner by replacing the toner cartridges 70y to 70k.

As illustrated in FIG. 2, the apparatus body 1A includes a frame 16 accommodating the rotary body 90. The frame 16 is a body frame of the image forming apparatus 1 of the present embodiment. The frame 16 is a casing or skeleton of the apparatus body 1A constituted by a frame and exterior members, and has an approximately rectangular parallelepiped shape.

The frame 16 has an opening 16a. More specifically, the frame 16 has a side surface 16b extending in a direction intersecting with the horizontal direction. The side surface 16b constitutes at least part of the exterior surface of the apparatus body 1A on the +X side. The opening 16a is provided in the side surface 16b. The side surface 16b is a side surface disposed on the downstream side of the discharge port in a discharge direction in which the sheet S on which an image has been formed is discharged from the apparatus body 1A through the discharge port. From the side surface 16b side of the image forming apparatus 1, the user can access the sheet storage portion 300 to replenish the sheet storage portion 300 with sheets S, and can obtain the sheet S discharged through the discharge port. Therefore, the side surface 16b can be referred to as the front surface of the apparatus body 1A.

The toner cartridges 70y, 70m, 70c, and 70k are attachable to and detachable from the rotary body 90 through the opening 16a. That is, the toner cartridge 70k can be referred to as an example of a first toner cartridge that stores toner to be supplied to the first developing roller (developing roller 51k) and that is attachable to and detachable from the rotary (rotary body 90) through the opening 16a of the frame 16 of the apparatus body 1A. The toner cartridge 70m can be referred to as an example of a second toner cartridge that stores toner to be supplied to the second developing roller (developing roller 51m) and that is attachable to and detachable from the rotary (rotary body 90) through the opening 16a of the frame 16 of the apparatus body 1A.

In the present embodiment, the toner cartridges 70y, 70m, 70c, and 70k are attached to and detached from the rotary body 90 through the opening 16a in the state of being supported by the trays 80y to 80k. In other words, the user can attach and detach the toner cartridges 70y to 70k to and from the rotary body 90 via the trays 80y to 80k.

The opening 16a is disposed in the side surface 16b of the frame 16. In the present embodiment, the side surface 16b is a surface approximately parallel to the rotational axis 90C of the rotary body 90. Therefore, in the case of replacing the toner cartridge 70, the toner cartridge 70 passes through the opening 16a in a direction intersecting with the rotational axis 90C (preferably a direction orthogonal to the rotational axis 90C).

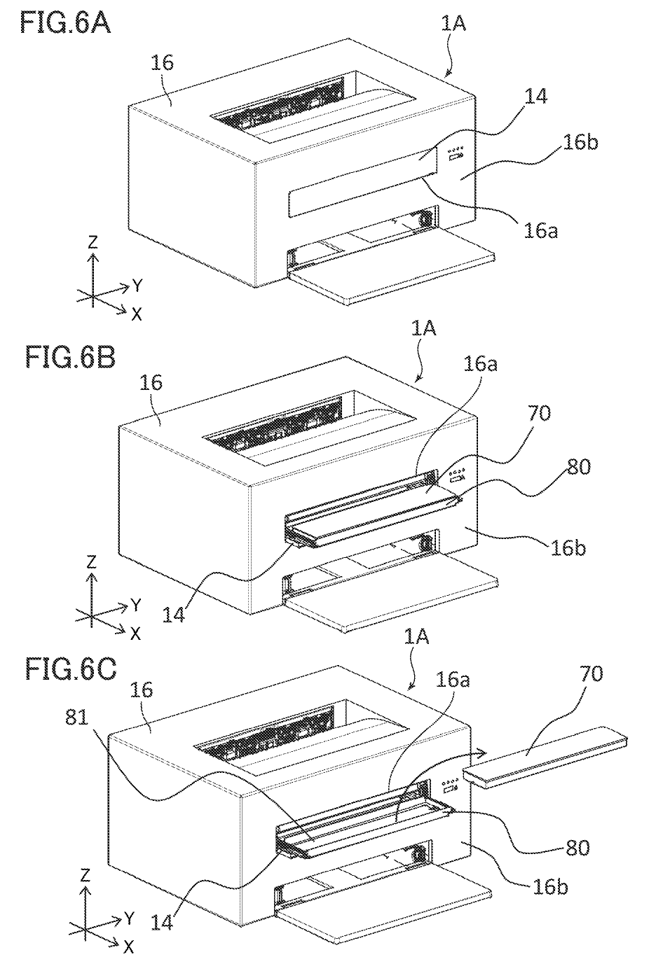

The image forming apparatus 1 includes a door 14 that covers the opening 16a of the frame 16. The door 14 is an opening/closing member movable to a closed position illustrated in FIG. 6A where the door 14 covers the opening 16a and an open position illustrated in FIGS. 6B and 6C where the opening 16a is exposed.

As described above, in the present embodiment, the toner cartridge 70 is configured to be attachable to and detachable from the rotary body 90 via the tray 80. Therefore, the toner cartridge 70 can be stably attached to and detached from the rotary body 90.

More specifically, the user can replace the toner cartridge 70 by an operation of attaching and detaching the toner cartridge 70 to and from the tray 80 configured to be movable with respect to the rotary body 90 (that is, with respect to the apparatus body 1A). In the case of a configuration in which the toner cartridge is replaced by the user directly inserting and removing the toner cartridge in and from the apparatus body, the user is required to insert the toner cartridge to a predetermined attached position in the apparatus body. In the present embodiment, the tray 80 is capable of moving such that the toner cartridge 70 moves to the attached position in a state in which the tray 80 is supporting the toner cartridge 70. Therefore, the user can replace the toner cartridge 70 by a simple operation of placing the toner cartridge 70 on the tray 80, and thus the operability is improved.

To be noted, the toner cartridge 70 has a thin elongated shape with the Y direction parallel to the rotational axis 90C of the rotary body 90 as a longitudinal direction. That is, the dimension of the toner cartridge 70 in the longitudinal direction is larger than its height and width in a cross-section orthogonal to the longitudinal direction. In the case of using the toner cartridge 70 having a thin elongated shape as described above, the toner cartridge 70 can be passed through the opening 16a in a short movement distance by providing the opening 16a in the side surface 16b of the frame 16 that is approximately parallel to the longitudinal direction (Y direction) of the toner cartridge 70. The replacement of the toner cartridge 70 becomes easier than, for example, a case where the toner cartridge 70 is inserted or removed through an opening provided in a side surface on one side (+Y side or -Y side) of the frame 16 in the longitudinal direction of the toner cartridge 70.

The rotary body 90 rotates about the rotational axis 90C, and thus can take a replacement posture in which detachment of one of the toner cartridges 70y to 70k from the rotary body 90 is allowed. A posture in which the detachment of the toner cartridge 70y is allowed will be referred to as a yellow replacement posture. A posture in which the detachment of the toner cartridge 70m is allowed will be referred to as a magenta replacement posture. A posture in which the detachment of the toner cartridge 70c is allowed will be referred to as a cyan replacement posture. A posture in which the detachment of the toner cartridge 70k is allowed will be referred to as a black replacement posture. The black replacement posture is an example of a first replacement posture in which detachment of a first toner cartridge from the rotary body 90 is allowed. The yellow/magenta/cyan replacement postures are examples of a second replacement posture in which detachment of a second toner cartridge from the rotary body 90 is allowed. The yellow/magenta/cyan/black replacement postures can be referred to as first to fourth replacement postures. This numbering is merely used for the sake of convenience of description, and can be interchanged appropriately in principle.

The rotary body 90 rotates about the rotational axis 90C in a counterclockwise direction of FIG. 2, and can sequentially take the yellow/magenta/cyan/black replacement postures. In the present embodiment, the rotary body 90 rotates about the rotational axis 90C in the counterclockwise direction of FIG. 2, and thus the developing posture and the replacement posture can be switched alternately. For example, in FIG. 2, the rotary body 90 is in the black developing posture. By rotating the rotary body 90 in the clockwise direction from this state, the posture of the rotary body 90 can be switched in the order of the cyan replacement posture, the yellow developing posture, the black replacement posture, the magenta developing posture, the yellow replacement posture, the cyan developing posture, and the magenta replacement posture. By rotating the rotary body 90 in the clockwise direction from the magenta replacement posture, the rotary body 90 returns to the black developing posture. That is, the rotary body 90 can rotate more than once (360°) in the clockwise direction.

FIG. 4A illustrates a cross-section of the rotary body 90 in a developing posture (specifically, the yellow developing posture). FIG. 4B illustrates a cross-section of the rotary body 90 in a replacement posture (specifically, the black replacement posture).

As illustrated in FIGS. 4A and 4B, the four trays 80y to 80k are attached to the rotary body 90. The trays 80y to 80k respectively hold the toner cartridges 70y to 70k. In FIGS. 4A and 4B, the trays 80y to 80k are accommodated in the rotary body 90, and this state can be referred to as a state in which the toner cartridges 70y to 70k are attached to the developing units 50y, 50m, 50c, and 50k.

As described above, the toner cartridge 70 is movable to an attached position and a retracted position where the toner cartridge 70 is retracted from the attached position, with respect to the developing frame 53 of the developing unit 50. That is, the first toner cartridge (toner cartridge 70k) is movable to a first attached position and a first retracted position with respect to a first storage frame (developing frame 53k). The second toner cartridge (toner cartridge 70m) is movable to a second attached position and a second retracted position with respect to a second storage frame (developing frame 53m).

In a state in which the toner cartridge 70 is at the attached position with respect to the developing frame 53, the discharge opening 71b and the inlet opening 53b face each other as illustrated in FIG. 3. The toner cartridge 70 is configured to supply toner to the developing-side storage portion 53a through the inlet opening 53b (opening of the storage frame) in this state.

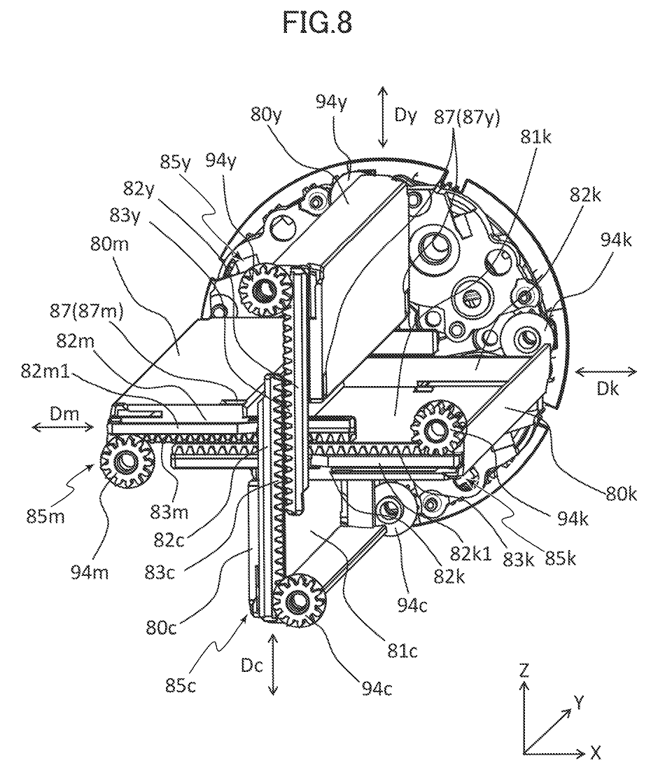

The apparatus body 1A includes a moving device 85 configured to move the toner cartridge 70 from the attached position to the retracted position with respect to the rotary body 90 (more specifically, with respect to the developing frame 53 of the developing unit 50). The moving device 85 will be described below with reference to FIG. 8 and the like. In the present embodiment, a plurality of moving devices 85y to 85k corresponding to the plurality of toner cartridges 70y to 70k are disposed in the rotary body 90. The trays 80y to 80k can be referred to as part of the moving devices 85y to 85k.

In the present embodiment, the toner cartridge 70k storing the black toner is larger in size than the toner cartridges 70y to 70c storing yellow toner, magenta toner, and cyan toner, and is capable of storing more toner. In other words, the first toner cartridge is capable of storing a first amount of toner, the second toner cartridge is capable of storing a second amount of toner, and the first amount is larger than the second amount.

Specifically, the length of the black toner cartridge 70k in a first radial direction with respect to the rotational axis 90C of the rotary body 90 is larger than the length of the magenta toner cartridge 70m in a second radial direction. Here, the first radial direction is a rotational radius direction (radial direction of a virtual circle centered on the rotational axis 90C) of the rotary body 90, and is a direction in which the toner cartridge 70k extends with respect to the rotational axis 90C as viewed in the direction of the rotational axis 90C. The second radial direction is a rotational radius direction of the rotary body 90, and is a direction in which the toner cartridge 70m extends with respect to the rotational axis 90C as viewed in the direction of the rotational axis 90C. Similarly, the length of the black toner cartridge 70k in the first radial direction is larger than the lengths of the other toner cartridges 70y and 70c in the radial directions corresponding to the toner cartridges 70y and 70c.

Accordingly, the tray 80k holding the black toner cartridge 70k is larger in size than the trays 80y to 80c holding the other toner cartridges 70y, 70m, and 70c. That is, the four toner cartridges 70y to 70k and the trays 80y to 80k having different sizes are disposed in the rotary body 90. In other words, the toner cartridge 70k serving as an example of a first toner cartridge and the toner cartridge 70y serving as an example of a second toner cartridge smaller than the first toner cartridge are attachable to and detachable from the rotary body 90. In accordance with this, the tray 80k serving as an example of a first support member that supports the first toner cartridge and the tray 80y serving as an example of a second support member smaller than the first support member are provided in the rotary body 90. In addition, the toner cartridges 70m and 70c serving as examples of a third toner cartridge and a fourth toner cartridge that are smaller in size than the first toner cartridge are attachable to and detachable from the rotary body 90. In accordance with this, the trays 80m and 80c serving as examples of a third support member and a fourth support member that are smaller in size than the first support member are provided in the rotary body 90.

Here, rotational driving of the rotary body 90 will be described with reference to FIG. 5. As illustrated in FIG. 5, disk gears 92L and 92R are formed on respective end portions of the rotary body 90. In addition, rotary driving gears 93L and 93R are formed on respective end portions of a swing shaft 91 in a manner capable of transmitting a driving force. Here, the driving force of the motor M1 is transmitted to the rotary driving gear 93R via a drive transmission mechanism. Next, the driving force is transmitted to the disk gears 92L and 92R via the rotary driving gears 93L and 93R, and thus the rotary body 90 is rotationally driven. The rotary body 90 rotates about the rotational axis 90C in the clockwise direction in FIG. 1.

In addition, the rotary body 90 is supported so as to be swingable about the swing shaft 91. The rotary body 90 is urged in a counterclockwise direction in FIGS. 4A and 4B about the swing shaft 91 by an urging member. This direction can be referred to as a direction in which the developing rollers 51y to 51k each approach the photosensitive drum 2. As a result of this, one of the developing rollers 51y to 51k is in contact with the photosensitive drum 2 in a state in which the rotary body 90 is in a developing posture.

Meanwhile, as illustrated in FIG. 5, rotary cams 90eL and 90eR are provided on respective end portions of the rotary body 90. When the rotary body 90 rotates about the rotational axis 90C in a clockwise direction in FIGS. 4A and 4B, the rotary cams 90eL and 90eR come into contact with a roller 96 supported by the frame 16 illustrated in FIGS. 4A and 4B. Then, the rotary body 90 moves in the clockwise direction in FIGS. 4A and 4B about the swing shaft 91. This direction can be referred to as a direction in which the developing rollers 51y to 51k each move away from the photosensitive drum 2. In addition, this direction can be referred to as a direction in which the rotary body 90 approaches the opening 16a of the frame 16 and the door 14.

As a result of this, when the rotary body 90 rotates and switches from the developing posture to the replacement posture, the rotary body 90 swings about the swing shaft 91. In a state in which the rotary body 90 is in the replacement posture, the developing roller 51 is separated from the photosensitive drum 2.

As illustrated in FIG. 4B, in the black replacement posture, the toner cartridge 70k stops at a position where the toner cartridge 70k faces the opening 16a and the door 14 provided on the side surface 16b of the apparatus body 1A. When the tray 80k is slid from the attached position for the developing unit 50k to the outside of the rotary body 90 from this state, the user can replace the toner cartridge 70k.

### Replacement Operation of Toner Cartridge

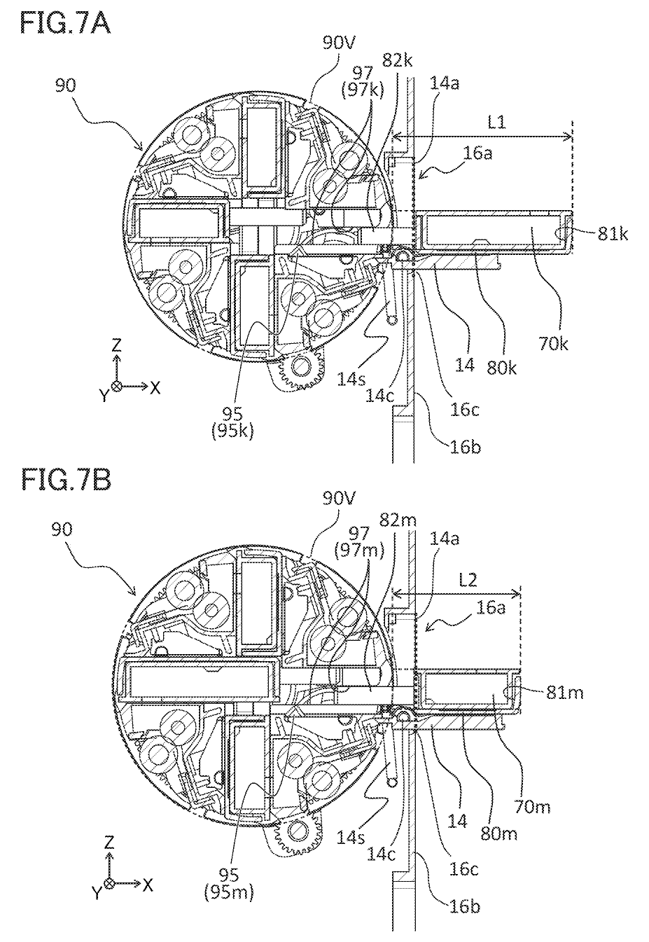

A toner cartridge replacement operation will be described with reference to FIGS. 4A, 6A to 6C, 7A, and 7B. FIGS. 6A to 6C are each an exterior view of the apparatus body 1A. FIGS. 7A and 7B are each a section view of the rotary body 90 and the surroundings thereof in toner cartridge replacement. To be noted, FIGS. 7A and 7B are each a section view of the apparatus taken along a virtual plane orthogonal to the rotational axis 90C of the rotary body 90.

FIG. 6A illustrates an external appearance of the apparatus body 1A during the image forming operation and in a standby state. During the image forming operation is during a period in which a series of operations of the image forming apparatus 1 feeding a sheet S, forming an image on the sheet S, and then discharging the sheet S as a product are executed. The standby state is a state in which the image forming operation can be started if the image forming apparatus 1 receives an image forming instruction (printing instruction), and a state in which the image forming apparatus 1 is standing by for the image forming instruction from the user. As illustrated in FIG. 6A, the door 14 is closed during the image forming operation and in the standby state.

FIG. 6B illustrates the external appearance of the apparatus body 1A at the time of toner cartridge replacement. At the time of toner cartridge replacement, the door 14 is opened, and the tray 80 and the toner cartridge 70 are moved to the outside of the apparatus body 1A.

The toner cartridge 70 is movable to an attached position and a retracted position where the toner cartridge 70 is retracted from the attached position, with respect to the developing frame 53 of the developing unit 50. In a state in which the toner cartridge 70 is at the attached position with respect to the developing frame 53, the discharge opening 71b and the inlet opening 53b face each other as illustrated in FIG. 3. As illustrated in FIGS. 4A and 4B, the rotary body 90 is configured to rotate about the rotational axis 90C to take the developing posture and the replacement posture in a state in which the toner cartridge 70 is at the attached position.

The toner cartridge replacement operation will be described. First, the user instructs the controller 30 of the apparatus body 1A a toner cartridge replacement operation. The instruction of toner cartridge replacement operation is given by, for example, input via an operation panel (operation portion) provided on the apparatus body 1A.

When the controller 30 receives the instruction of the toner cartridge replacement operation, the rotary body 90 rotates to the replacement posture of the toner cartridge 70 serving as a replacement target (toner cartridge 70 whose toner has run out), and stops. That is, the controller 30 rotates the rotary body 90 to the replacement posture of a toner cartridge specified in the instruction of the toner cartridge replacement (in FIG. 4B, the black replacement posture for replacing the black toner cartridge 70k). In the replacement posture, the tray 80 supporting the toner cartridge 70 whose replacement has been instructed faces the opening 16a of the frame 16 of the apparatus body 1A.

For example, the rotary body 90 of FIG. 4A is in the yellow developing posture in which the yellow developing roller 51y faces the photosensitive drum 2. At this time, the black toner cartridge 70k and the tray 80k do not have to face the opening 16a and the door 14. In other words, the toner cartridge 70 and the tray 80 do not have to face the opening 16a and the door 14 in the case where the rotary body 90 is in a developing posture or a replacement posture other than the replacement posture of the toner cartridge. Therefore, the opening 16a may have such a size that each of the toner cartridges 70 can individually pass therethrough. When the rotary body 90 rotates in the clockwise direction in the drawings by a predetermined angle from the yellow developing posture, the black toner cartridge 70k and the tray 80k face the opening 16a and the door 14 as illustrated in FIG. 4B.

Here, “the tray 80 facing the opening 16a” means that the tray 80 is positioned so as to be able to move to the outside of the apparatus body 1A through the opening 16a. That is, in the case where the tray 80 faces the opening 16a, a moving mechanism that will be described later moves the tray 80 outward in the rotational radius direction of the rotary body 90, and therefore the tray 80 and the toner cartridge 70 supported by the tray 80 are capable of projecting to the outside of the apparatus body 1A. In FIG. 4A, none of the trays 80y to 80k faces the opening 16a. In FIG. 4B, only the black tray 80k faces the opening 16a, and the other trays 80y to 80c do not face the opening 16a.

When the rotary body 90 is positioned in the replacement posture, the motor M2 moves the tray 80 supporting the toner cartridge 70 serving as a replacement target to the outside of the apparatus body 1A. As a result of this, the toner cartridge 70 serving as a replacement target moves from the attached position to the retracted position with respect to the rotary body 90. In addition, as illustrated in FIGS. 6B, 6C, 7A, and 7B, the tray 80 and the toner cartridge 70 serving as a replacement target supported by the tray 80 projects to the outside of the apparatus body 1A through the opening 16a.

More specifically, the tray 80 is movable to an accommodation position and a detachment position with respect to the rotary body 90. The accommodation position is a position where the tray 80 is accommodated in the rotary body 90. The detachment position is a position (removal position or replaceable position) where the tray 80 projects to the outside of the rotary body 90 and the toner cartridge 70 can be detached from the tray 80. The positions of the trays 80y to 80k in FIGS. 4A and 4B serve as examples of the accommodation position. The position of the tray 80 in FIGS. 6B and 6C, the position of the tray 80k in FIG. 7A, and the position of the tray 80m in FIG. 7B serve as examples of the detachment position.

When the tray 80 is at the accommodation position, the toner cartridge 70 attached to the tray 80 is positioned at the attached position. When the tray 80 is at the detachment position, the toner cartridge 70 attached to the tray 80 is positioned at the retracted position.

Here, as illustrated in FIGS. 7A and 7B, the rotary body 90 has projection portions 95 for holding the tray 80 at the accommodation position and holding the toner cartridge 70 at the attached position. As illustrated in FIG. 8, the tray 80 has recess portions 87 configured to be fit on the projection portions 95. FIGS. 7A and 7B illustrate projection portions 95k and 95m corresponding to the trays 80k and 80m, and FIG. 8 illustrates recess portions 87y and 87m of the trays 80y and 80m. The projection portion 95 and the recess portion 87 are provided for each of the trays 80y to 80k. The projection portion 95 is preferably urged in such a direction as to engage with the recess portion 87.

The projection portion 95 fits in the recess portion 87 of the tray 80, and thus the tray 80 is locked with respect to the rotary frame 90f. As a result of this, the tray 80 stays in the accommodation position even when the rotary body 90 rotates, and thus movement of the toner cartridge 70 from the attached position can be suppressed. To be noted, in the case where the tray 80 is moved between the accommodation position and the detachment position by the moving device that will be described below, the projection portion 95 can be configured to be moved by the tray 80 and thus disengaged from the recess portion 87.

In the present embodiment, the door 14 is supported so as to be pivotable with respect to the apparatus body 1A. As illustrated in FIG. 7A, the door 14 is urged from the open position to the closed position by a spring 14s. The spring 14s is, for example, a tension spring, and urges the door 14 such that a moment in a counterclockwise direction in FIGS. 7A and 7B is generated about a support shaft 14c of the door 14.

The tray 80 pushes the door 14, and thus the door 14 takes the open state illustrated in FIG. 6B. This state can be referred to as a state in which the tray 80 is supported by the door 14. The door 14 supports at least part of the tray 80 projecting to the outside of the apparatus body 1A, and thus the toner cartridge 70 can be supported more stably. In other words, when the first toner cartridge (toner cartridge 70k) is at the first retracted position, the opening/closing member (door 14) at the open position supports the first support member (tray 80k). In addition, when the second toner cartridge (one of the toner cartridges 70y to 70c) is at the second retracted position, the opening/closing member (door 14) at the open position supports the second support member (one of the trays 80y to 80c).

To be noted, the door 14 is configured such that the door 14 at the open position comes in contact with part (for example, a lower edge 16c of the opening 16a) of the frame 16 of the apparatus body 1A and not to pivot downward beyond the open position. When the tray 80 is pulled back into the apparatus body 1A from the outside, the door 14 returns to the closed position by the urging force of the spring 14s.

The toner cartridge 70 is detachably held by the tray 80. Therefore, as illustrated in FIG. 6C, the user can perform a work (replacement work) of detaching the toner cartridge 70 from the tray 80 and attaching a new toner cartridge 70. To be noted, in the case of replacing a plurality of toner cartridges 70, the replacement work can be performed by repeating the operation described above.

FIGS. 7A and 7B illustrate a cross-section of the rotary body 90 and the surroundings thereof at the time of toner cartridge replacement. FIG. 7A illustrates a state at the time of replacing the black toner cartridge 70k. FIG. 7B illustrates a state at the time of replacing the magenta toner cartridge 70m.

The image forming apparatus 1 includes the moving devices 85y, 85m, 85c, and 85k illustrated in FIG. 8 that respectively move the toner cartridges 70y, 70m, 70c, and 70k from the attached position to the retracted position. When referring to a “moving device 85” in which the suffices y, m, c, and k are omitted, it basically represents arbitrary one of the moving devices 85y, 85m, 85c, and 85k. In the present embodiment, it can be said that the moving device 85 includes the tray 80. A moving device 85k including the tray 80k can be referred to as an example of a first moving device including a first support member. A moving device 85m including the tray 80m can be referred to as an example of a second moving device including a second support member.

Even when the toner cartridge 70 is at the retracted position, the tray 80 is coupled to the rotary body 90 (supported by the rotary body 90). To easily detach the toner cartridge 70 from the rotary body 90, it is preferable that the length by which the toner cartridge 70 projects from the rotary body 90 at the retracted position is large. Since the toner cartridge 70 is configured to be attachable to and detachable from the rotary body 90 via the tray 80, the toner cartridge 70 can be stably supported by the tray 80 even in the case where the length by which the toner cartridge 70 projects from the rotary body 90 is large.

The movement direction of the toner cartridge 70 in which the toner cartridge 70 moves from the attached position to the retracted position will be referred to as a retraction direction. In the present embodiment, the retraction direction of the toner cartridge 70 is a direction intersecting with the direction of the rotational axis 90C (Y direction). Therefore, as illustrated in FIGS. 7A and 7B, as viewed in the direction of the rotational axis 90C (Y direction), the retraction direction of the toner cartridge 70 is a direction orthogonal to the direction of the rotational axis 90C (Y direction). In addition, the retraction direction of the toner cartridge 70 can be referred to as a direction outward in the rotational radius direction of the rotary body 90, that is, a direction away from the rotational axis 90C.

As illustrated in FIGS. 7A and 7B, since the user detaches the toner cartridge 70 from the rotary body 90, it is preferable that the at least part of the toner cartridge 70 projects from the rotary body 90 at the time of detaching the toner cartridge 70. In the present embodiment, the entirety of the toner cartridge 70 projects from the rotary body 90 when the toner cartridge 70 is at the retracted position.

It can be said that when the rotary body 90 rotates about the rotational axis 90C, the rotational trajectory of the rotary body 90 matches a circumscribed circle of the rotary body 90 centered on the rotational axis 90C, that is, a virtual circle 90V indicated by a broken line in FIGS. 7A and 7B. When the toner cartridge 70 is at the retracted position, half the length or more of the toner cartridge 70 in the retracted direction is preferably outside the rotational trajectory of the rotary body 90. That is, as viewed in the rotational axis direction of the rotary, half the total length or more of the toner cartridge is preferably positioned outside the rotational trajectory of the rotary in the movement direction of the toner cartridge from the attached position to the retracted position. This applies to the toner cartridges 70 including the toner cartridge 70k serving as an example of the first cartridge and the toner cartridge 70m serving as an example of the second cartridge. In addition, in the present embodiment, the entirety of the toner cartridge 70 is outside the rotational trajectory (virtual circle 90V) of the rotary body 90 when the toner cartridge 70 is at the retracted position as illustrated in FIGS. 7A and 7B.

Further, to make it easier for the user to grab the toner cartridge 70, at least part of the toner cartridge 70 is preferably outside the image forming apparatus 1, that is, outside the apparatus body 1A when the toner cartridge 70 is at the retracted position. The outside of the apparatus mentioned herein refers to a space that is outside the image forming apparatus 1 (outside the apparatus body 1A) when the image forming apparatus 1 is used for, for example, an image forming operation on the sheet S.

In the present embodiment, the exterior surface of the apparatus body 1A is constituted by the exterior surface of the frame 16. That is, outside the apparatus can be also referred to as outside the frame 16. Therefore, a state in which at least part of the toner cartridge 70 is outside the apparatus can be also referred to as a state in which at least part of the toner cartridge 70 projects to the outside of the frame 16 through the opening 16a of the frame 16 of the apparatus body 1A.

In the present embodiment, when the door 14 is at the closed position, the opening 16a of the frame 16 of the apparatus body 1A is covered by the door 14. Further, the exterior surface 14a of the door 14 at the closed position constitutes part of the exterior surface of the apparatus body 1A. In this case, outside of the apparatus refers to the outside of the exterior surface 14a of the door 14 at the closed position. That is, in the case where the position of the exterior surface 14a of the door 14 at the closed position is referred to as an exterior position, at least part of the toner cartridge 70 is positioned more outward than the exterior position with respect to the apparatus body 1A when the toner cartridge 70 is at the retracted position.

In other words, at least part of the toner cartridge 70 is positioned in a space that would be outside the apparatus body 1A if the door 14 were at the closed position. Further, at least part of the toner cartridge 70 is positioned downstream of the exterior position in the retraction direction of the toner cartridge 70.

In addition, in the case where the side surface 16b having the opening 16a is the front surface of the apparatus body 1A, it can be said at least part of the toner cartridge 70 projects to the front side more than the exterior surface on the front side of the apparatus body 1A when the toner cartridge 70 is at the retracted position. In this case, the user can easily access the toner cartridge 70 from the front side of the image forming apparatus and replace the toner cartridge 70.

To be noted, when the toner cartridge 70 is at the retracted position, half the length or more of the toner cartridge 70 in the retraction direction is preferably outside the apparatus. That is, as viewed in the rotational axis direction of the rotary, half the total length or more of the toner cartridge is preferably positioned outside the body frame in the movement direction of the toner cartridge from the attached position to the retracted position in a state in which the toner cartridge is at the retracted position. This applies to the toner cartridges 70 including the toner cartridge 70k serving as an example of the first toner cartridge and the toner cartridge 70m serving as an example of the second toner cartridge. In addition, the entirety of the toner cartridge 70 is preferably outside the apparatus when the toner cartridge 70 is at the retracted position. To be noted, although the exterior surface 14a of the door 14 and the side surface 16b constitute the exterior surface on the front side of the apparatus body 1A in the present embodiment, the configuration of the door 14 is not limited to this. For example, the size of the door 14 may be set so as to cover the entirety of the side surface 16b. In this case, the exterior surface 14a of the door 14 constitutes the exterior surface on the front side of the apparatus body 1A.

The tray 80 includes a cartridge holding portion 81 illustrated in FIG. 6C that holds the toner cartridge 70. The cartridge holding portion 81 is an attached portion to which the toner cartridge 70 is attached. When the tray 80 is at the detachment position, the entirety of the cartridge holding portion 81 is preferably outside the rotational trajectory of the rotary body 90 in the retraction direction. When the tray 80 is at the detachment position, half the length or more of the cartridge holding portion 81 is preferably outside the apparatus in the retraction direction.

Here, as described above, the toner cartridge 70k and the tray 80k are larger in size than the other toner cartridges 70y to 70c and the other trays 80y to 80c. Therefore, as illustrated in FIGS. 7A and 7B, in the present embodiment, the movement amount of the tray 80 in toner cartridge replacement is changed in accordance with the size of the toner cartridge 70.

Specifically, as illustrated in FIG. 7A, the movement distance of the tray 80k (first support member) from the accommodation position (first accommodation position) to the detachment position (first detachment position) is L1. The movement distance of the tray 80m (second support member) from the accommodation position to the detachment position (third detachment position) is L2. Although a state in which the toner cartridge 70m and the tray 80m are moved is illustrated in FIG. 7B, the movement distance of the trays 80y and 80c from the accommodation position to the detachment position is also L2. In this case, L1 is larger than L2. In other words, it can be said that the movement distance of the first support member in the case where the first toner cartridge moves from the first attached position to the first retracted position is larger than the movement distance of the second support member in the case where the second toner cartridge moves from the second attached position to the second retracted position.

In addition, as illustrated in FIG. 7A, in a state in which the tray 80k is at the detachment position and the toner cartridge 70k is at the retracted position, at least part of the toner cartridge 70k projects from the exterior surface of the apparatus body 1A to the outside of the apparatus. In the present embodiment, at least part of the tray 80k also projects from the exterior surface of the apparatus body 1A to the outside of the apparatus. In addition, as illustrated in FIG. 7B, in a state in which the tray 80m is at the detachment position and the toner cartridge 70m is at the retracted position, at least part of the toner cartridge 70m projects from the exterior surface of the apparatus body 1A to the outside of the apparatus. In the present embodiment, at least part of the tray 80m also projects from the exterior surface of the apparatus body 1A to the outside of the apparatus. To be noted, at least part of the toner cartridges 70y and 70c also project from the exterior surface of the apparatus body 1A to the outside of the apparatus.

### Tray Arrangement in Rotary

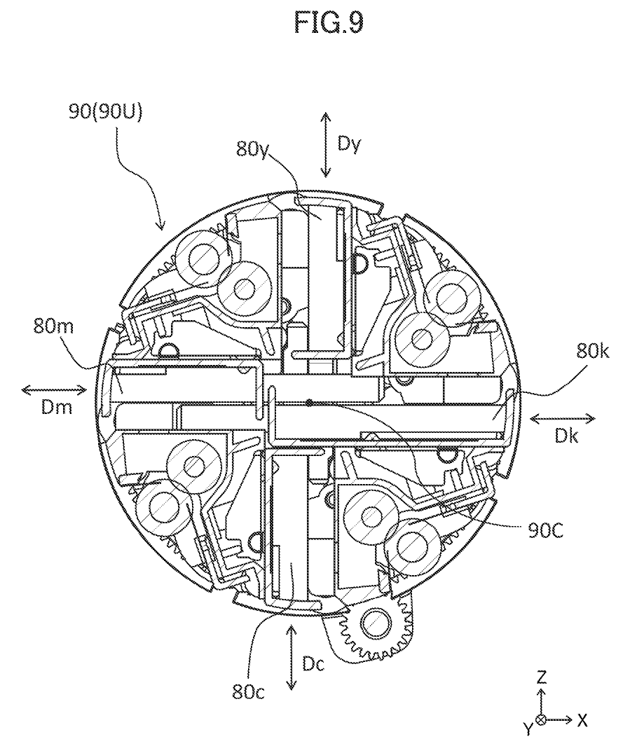

The arrangement of the trays 80y to 80k in the rotary body 90 will be described with reference to FIGS. 8 and 9. FIG. 8 is a perspective view illustrating the arrangement of the trays 80y to 80k in the rotary body 90. FIG. 9 is a section view illustrating the arrangement of the trays 80y to 80k in the rotary body 90. To be noted, FIG. 9 illustrates a cross-section of the rotary body 90 taken along a virtual plane orthogonal to the rotational axis 90C of the rotary body 90.

As illustrated in FIG. 8, the trays 80y to 80k are respectively provided with cartridge holding portions 81y to 81k and guided portions 82y to 82k.

The toner cartridges 70y to 70k are respectively attached to the cartridge holding portions 81y to 81k. The cartridge holding portions 81y to 81k respectively accommodate at least part of the toner cartridges 70y to 70k attached thereto.

The guided portions 82y to 82k are provided at respective end portions of the trays 80y to 80k such that the cartridge holding portions 81y to 81k are each interposed therebetween in the Y direction. The guided portions 82y to 82k are each a thin and long member extending in a direction orthogonal to the rotational axis of the rotary body 90.

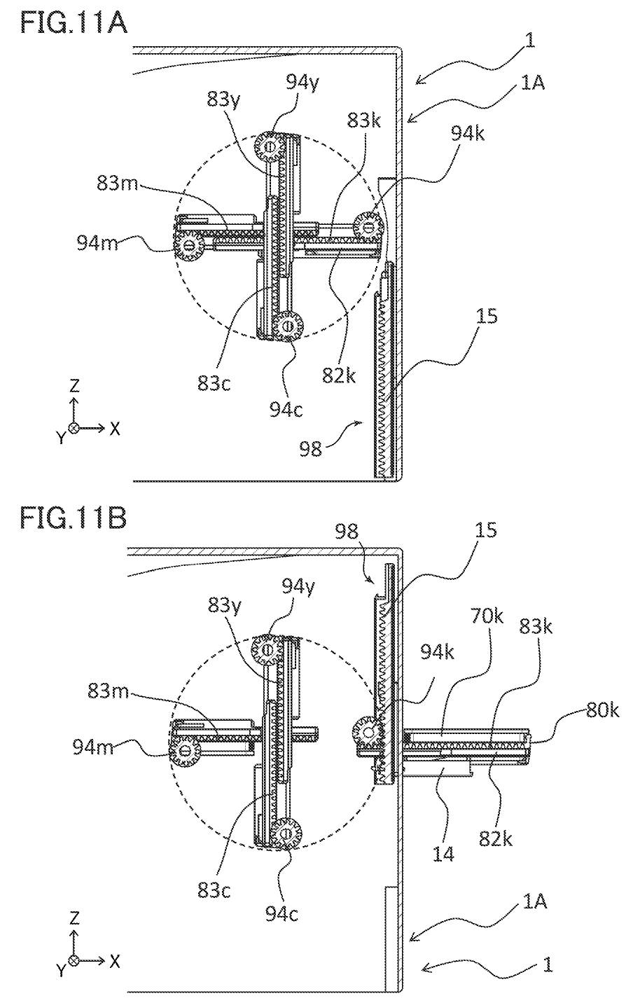

In the present embodiment, a reinforcing rib 82k1 is formed on part of the guided portion 82k in a movement direction Dk of the tray 80k, and a reinforcing rib 82m1 is formed on part of the guided portion 82m in a movement direction Dm of the tray 80m (see also FIGS. 11A and 11B. The reinforcing ribs 82k1 and 82m1 are thin and long rib shapes (ridges) projecting outward in the Y direction from the guided portions 82k and 82m of the respective end portions of the trays 80k and 80m in the Y direction and extending in the movement directions Dk and Dm of the trays 80k and 80m. The reinforcing ribs 82k1 and 82m1 improve the stiffness of the guided portions 82k and 82m.

To be noted, although the lengths of the reinforcing ribs 82m1 and 82k1 in the present embodiment are restricted so as to avoid the guided portions 82y and 82c, the reinforcing ribs 82m1 and 82k1 may be provided for the entire lengths of the guided portions 82m and 82k unless interference with the guided portions 82y and 82c occurs. Reinforcing ribs may be added to the guided portions 82y and 82c. In addition, in the case where the stiffness of the guided portions 82m and 82k is sufficient, a configuration in which the reinforcing ribs 82m1 and 82k1 are not provided may be employed.

The guided portions 82y to 82k have rack portions (rack gears) 83y to 83k formed therein. In addition, pinion gears 94y to 94k are rotatably held in the rotary body 90. The pinion gears 94y to 94k are respectively engaged with the rack portions 83y to 83k in a manner capable of transmitting a driving force.

The rack portions 83y to 83k and the pinion gears 94y to 94k are part of the moving devices 85y to 85k configured to move the toner cartridges 70y to 70k from the attached position to the retracted position. In addition, it can be said that the rack portions 83y to 83k and the pinion gears 94y to 94k are part of a driven device driven by the driving device 98 of the apparatus body 1A. It can be said that the pinion gears 94y to 94k are rotatable bodies (rotary members) that rotate to move the trays 80y to 80k with respect to the rotary body 90.

The pinion gears 94y to 94k and the rack portions 83y to 83k function as driven portions for the moving devices 85y to 85k of the rotary body 90 to receive the driving force from the driving device 98 of the apparatus body 1A. The pinion gear 94k and the rack portion 83k are examples of a first pinion gear and a first rack gear constituting at least part of a first driven portion included in a first moving device. The pinion gear 94m and the rack portion 83m are examples of a second pinion gear and a second rack gear constituting at least part of a second driven portion included in a second moving device.

The rotary body 90 includes guide portions 97 illustrated in FIGS. 7A and 7B that respectively engage with the guided portions 82y to 82k. FIG. 7A illustrates the guide portion 97 (97k) that engages with the guided portion 82k of the tray 80k, and FIG. 7B illustrates the guide portion 97 (97m) that engages with the guided portion 82m of the tray 80m. The rotary body 90 includes similar guide portions that respectively engage with the guided portions 82y and 82c of the trays 80y and 80c. In addition, although the guide portions 97 provided on one side (+Y side) of the rotary body 90 in the Y direction are illustrated in FIGS. 7A and 7B, similar guide portions 97 are also provided on the other side (-Y side) of the rotary body 90 in the Y direction.

When the tray 80 moves between the accommodation position and the detachment position, the guide portion 97 maintains the state of engaging with the guided portion 82 in at least part of the movement range, and guides the movement direction of the tray 80. In the present embodiment, the guide portion 97 maintains the state of engaging with the guided portion 82k in the entirety of the movement range of the tray 80k between the accommodation position and the detachment position. In addition, in the present embodiment, the guide portion 97 maintains the state of engaging with the guided portion 82m in the entirety of the movement range of the tray 80m between the accommodation position and the detachment position.

In addition, as illustrated in FIGS. 8 and 9, the four trays 80y to 80k are disposed in the rotary body 90 so as to overlap each other as will be described in detail below.

When the pinion gears 94y to 94k rotate, the rack portions 83y to 83k and the trays 80y to 80k move with respect to the rotary body 90. As illustrated in FIG. 9, the four trays 80y to 80k are arranged such that the movement directions thereof with respect to the rotary body 90 are rotated by 90° from each other. Therefore, the tray 80y and the tray 80c are held so as to be slidable in substantially the same direction (parallel directions) as each other, and the tray 80m and the tray 80k are held so as to be slidable in substantially the same direction (parallel directions) as each other. The movement directions of sliding of the trays 80y to 80k are regulated by the engagement between the guide portions 97 and the guided portions 82y to 82k described above.

To be noted, the trays 80y to 80k move to the outside of the apparatus through the opening 16a. When the trays 80y to 80k each move to the outside of the apparatus through the opening 16a, the movement directions of the trays are substantially the same (parallel).

As illustrated in FIG. 9, the trays are disposed such that with respect to the movement direction Dk of the tray 80k, the range in which the tray 80k is disposed overlaps with the range in which the tray 80y is disposed and the range in which the tray 80c. In addition, with respect to the movement direction Dk of the tray 80k, the range in which the tray 80k is disposed overlaps with the rotational axis 90C of the rotary body 90. That is, it can be said that the toner cartridge 70k held by the cartridge holding portion 81k of the tray 80k overlaps with the rotational axis 90C of the rotary body 90 illustrated in FIG. 4B.

In contrast, the trays are disposed in a displaced manner such that with respect to the movement direction Dm of the tray 80m, the range in which the tray 80m is disposed does not overlap with the range in which the tray 80y is disposed and the range in which the tray 80c is disposed. Further, the trays are disposed in a displaced manner such that with respect to a movement direction Dy of the tray 80y, the range in which the tray 80y is disposed does not overlap with the range in which the tray 80m is disposed and the range in which the tray 80k is disposed. Similarly, the trays are disposed in a displaced manner such that with respect to a movement direction Dc of the tray 80c, the range in which the tray 80c is disposed does not overlap with the range in which the tray 80m is disposed and the range in which the tray 80k is disposed.

The positional relationship between the trays 80 can be also expressed as follows. As viewed in the movement direction Dy of the tray 80y, the tray 80y and the tray 80k overlap with each other, but the tray 80y and the tray 80m do not overlap with each other. As viewed in the movement direction Dm of the tray 80m, the tray 80m and the tray 80k overlap with each other, but the tray 80m and the trays 80y and 80c do not overlap with each other. As viewed in the movement direction Dc of the tray 80c, the tray 80c and the tray 80k overlap with each other, but the tray 80c and the tray 80m do not overlap with each other.

Here, two elements (such as members, parts, and units) overlapping as viewed in a specific direction refers to a projected region of one element and a projected region of the other element at least partially overlapping with each other in the case where the elements are orthogonally projected onto a virtual plane orthogonal to the specific direction.

As illustrated in FIG. 8, with respect to the direction of the rotational axis 90C (Y direction), a range in which the rack portion 83m and the guided portion 82m are disposed and a range in which the rack portion 83k and the guided portion 82k are disposed overlap with each other at least partially. That is, in the present embodiment, it can be said that with respect to the rotational axis direction of the rotary (Y direction), a range in which the first rack gear (rack portion 83k) is disposed and a range in which the second rack gear (rack portion 83m) is disposed overlap with each other at least partially. Therefore, as compared with a layout in which the rack portion 83m and the guided portion 82m do not overlap with the rack portion 83k and the guided portion 82k, the rack portions 83m and 83k and the guided portions 82m and 82k can be arranged in a smaller space in the Y direction.

With respect to the direction of the rotational axis 90C (Y direction), a range in which the rack portion 83y and the guided portion 82y are disposed and a range in which the rack portion 83c and the guided portion 82c are disposed overlap with each other at least partially. That is, in the present embodiment, it can be said that with respect to the rotational axis direction of the rotary (Y direction), a range in which the third rack gear (rack portion 83y) is disposed and a range in which the fourth rack gear (rack portion 83c) is disposed overlap with each other at least partially. Therefore, as compared with a layout in which the rack portion 83y and the guided portion 82y do not overlap with the rack portion 83c and the guided portion 82c, the rack portions 83y and 83c and the guided portions 82y and 82c can be arranged in a smaller space in the Y direction.

### Moving Elements of Tray

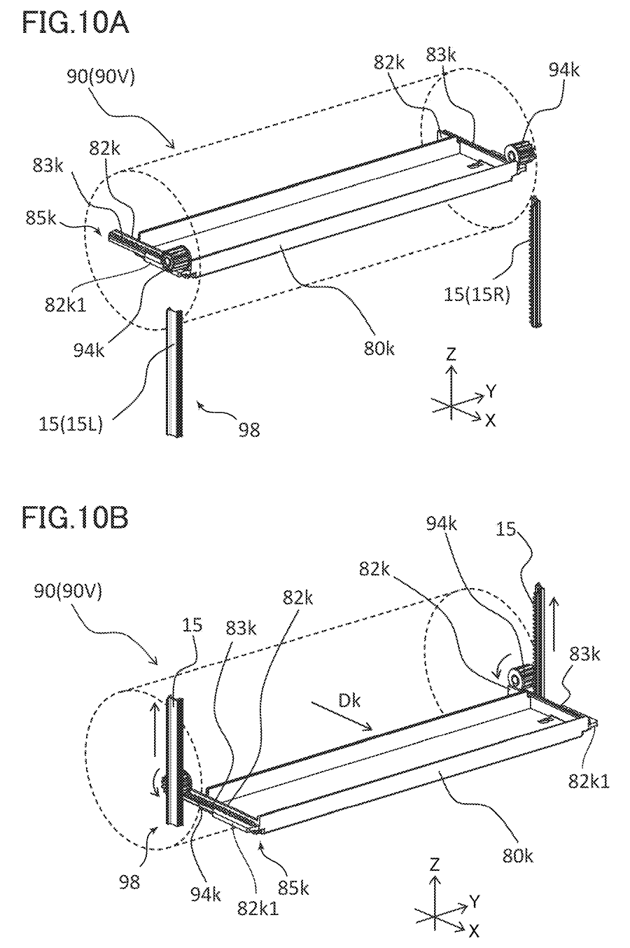

Elements related to the movement of the trays 80y to 80k disposed in the rotary body 90 will be described with reference to FIGS. 10A, 10B, 11A, and 11B. FIGS. 10A and 10B are each a perspective view of elements related to the movement of the tray 80k. FIGS. 11A and 11B are each a section view of elements related to the movement of the tray 80k.

In the present embodiment, the trays 80y to 80k are respectively driven by receiving the driving force of the motor M2 transmitted to the pinion gears 94y to 94k via the driving racks 15L and 15R serving as transmission devices. Here, the elements for moving the tray 80k with respect to the rotary body 90 will be described, and since the elements for moving the trays 80y to 80c with respect to the rotary body 90 are substantially the same as the elements for moving the tray 80k, description thereof will be omitted.

FIG. 10A illustrates a state in which the tray 80k is inside the rotary body 90, that is, in a state in which the toner cartridge 70k is attached to the developing unit 50k. That is, FIG. 10A illustrates a state in which the tray 80k is at the accommodation position, and corresponds to a state in which the toner cartridge 70k is at the attached position with respect to the developing frame 53k illustrated in FIG. 4A. FIG. 10B illustrates a state in which the tray 80k has slid to the outside of the rotary body 90. That is, FIG. 10B illustrates a state in which the tray 80k is at the detachment position, and corresponds to a state in which the toner cartridge 70k is at the retracted position with respect to the developing frame 53k illustrated in FIG. 4B.

The apparatus body 1A of the present embodiment includes the driving racks 15L and 15R serving as driving gears that drive the pinion gears 94. The driving racks 15L and 15R are each driven by the motor M2 via an unillustrated drive transmission mechanism.

As described above, two rack portions 83k are formed at respective end portions of the tray 80k in the Y direction. Two pinion gears 94k and the driving racks 15L and 15R are disposed at positions respectively corresponding to the rack portions 83k at the respective end portions. That is, the apparatus body 1A of the present embodiment includes the driving racks 15L and 15R serving as the first driving gear and the second driving gear. It can be said that the driving rack 15L is an example of a first driving gear, and the driving rack 15R is an example of a second driving gear. However, this numbering is merely used for the sake of convenience of description, and can be appropriately interchanged in principle. In the case where there is no need to distinguish the driving racks 15L and 15R from each other, the driving racks will be each described as a “driving rack 15”.

The rack portions 83 of the present embodiment are configured as a pair of rack gears, and the pinion gears 94 of the present embodiment are configured as a pair of pinion gears. The pair of rack gears and the pair of pinion gears are disposed on the two end sides (i.e., one end side and the other end side) of the support member (tray 80) in the Y direction in the present embodiment, but the pair of rack gears and the pair of pinion gears may be disposed at other positions. The rack portions 83k and the pinion gears 94k of the moving device 85k corresponding to the tray 80k can be respectively referred to as examples of a first pair of rack gears and a first pair of pinion gears. The rack portions 83y to 83c and the pinion gears 94y to 94c of the moving devices 85y to 85c respectively corresponding to any one of the other trays 80y to 80c can be respectively referred to as examples of second pairs of rack gears and second pairs of pinion gear.

One of the pair of rack gears engages with one of the pair of pinion gears, and the other of the pair of rack gears engages with the other of the pair of pinion gears. At least one of the pair of pinion gears is driven by the driving rack 15L serving as a first driving rack. In the present embodiment, two of the pair of pinion gears are simultaneously driven by the driving racks 15L and 15R serving as a first driving rack and a second driving rack. As a result of this, rotation of the tray 80 is less likely to occur, and thus stable movement of the toner cartridge 70 is made possible.

To be noted, a configuration in which the tray 80 includes one rack portion 83 and is moved by one driving rack 15 via one pinion gear 94 may be employed.

The tray 80k is held to be slidable in a direction parallel to the guided portion 82k (that is, the movement direction Dk) with respect to the rotary body 90. The driving rack 15 is held to be slidable in a direction intersecting with the movement direction Dk of the tray 80k with respect to the apparatus body 1A. The driving rack 15 is configured to slide (reciprocate) in a first direction (vertically upward direction in the present embodiment) and a second direction (vertically downward direction in the present embodiment) opposite to the first direction, with respect to the apparatus body 1A. That is, the movement direction of the driving rack 15 of the present embodiment is a direction intersecting with (preferably orthogonal to) both the movement direction Dk of the tray 80k and the direction of the rotational axis 90C of the rotary body 90 (Y direction).

A tray moving operation of sliding the tray 80k between the accommodation position and the detachment position will be described with reference to FIGS. 10A and 10B. The tray moving operation of the tray 80k is performed by the motor M2 illustrated in FIG. 2, unillustrated drive transmission mechanism, the driving rack 15, the pinion gear 94k, and the rack portion 83k.

First, a tray moving operation (tray pull-out operation) of detaching the toner cartridge 70k from the rotary body 90 will be described. In a state before the tray pull-out operation is started, the driving rack 15 illustrated in FIG. 11A is positioned below a position where the driving rack 15 engages with the pinion gear 94k. In addition, as described above, in the replacement operation of the toner cartridge 70k, the rotary body 90 takes the replacement posture illustrated in FIG. 4B for the toner cartridge 70k.

When the tray pull-out operation is started, the driving racks 15 are slid upward with respect to the apparatus body 1A by the driving force of the motor M2. In the course of movement of the driving racks 15, the driving racks 15 engage with the pinion gears 94k, and the pinion gears 94k are rotationally driven.

As illustrated in FIG. 11B, the pinion gears 94k are rotationally driven in an arrow direction in FIG. 11B, and thus the driving force is input to the rack portions 83k engaged with the pinion gears 94k. As a result of this, the tray 80k is pushed to the outside of the apparatus, and moves from the accommodation position to the detachment position with respect to the rotary body 90. The movement direction of the tray 80k in this movement is guided to the predetermined movement direction Dk by the engagement between the guided portion 82k and the guide portion 97k of the rotary body 90 illustrated in FIG. 7A. As a result of the tray 80k moving from the accommodation position to the detachment position, the toner cartridge 70k is moved from the attached position to the retracted position with respect to the developing unit 50k.

In a state in which the tray 80k is positioned at the detachment position and the toner cartridge 70k is positioned at the retracted position, the user can attach and detach the toner cartridge 70k to and from the tray 80k.

The tray moving operation (tray pull-in operation or tray insertion operation) at the time of attaching the toner cartridge 70 to the rotary body 90 is performed in a process reversed from the tray pull-out operation. For example, the tray pull-in operation is started in response to the user operating a predetermined operation portion. When the tray pull-in operation is started, the driving racks 15 are slid downward with respect to the apparatus body 1A by the driving force of the motor M2. Here, the rotational direction of the motor M2 in the tray pull-in operation is opposite to that in the tray pull-out operation.

As a result of the pinion gears 94k being rotationally driven in a direction opposite to the arrow of FIG. 11B, the driving force is input to the rack portions 83k engaged with the pinion gears 94k. As a result of this, the tray 80k is pulled into the apparatus, and moves from the detachment position to the accommodation position with respect to the rotary body 90. The movement direction of the tray 80k is guided to the movement direction Dk opposite to the arrow of FIG. 11B by the engagement between the guided portion 82k and the guide portion 97k of the rotary body 90. As a result of the tray 80k moving from the detachment position to the accommodation position, the toner cartridge 70k is moved from the retracted position to the attached position with respect to the developing unit 50k.

Movement of the tray 80k and the toner cartridge 70k for black has been described above, and movement of the other trays 80y to 80c and toner cartridges 70y to 70c is also performed by a similar mechanism. That is, the driving racks 15 transmit drive to the pinion gears 94y to 94c in respective replacement postures of the toner cartridges.

The motor M2 provided in the apparatus body 1A and the transmission device including the driving racks 15 (15L and 15R) and the drive transmission mechanism constitute the driving device 98 for driving the moving devices 85 provided in the rotary body 90.

As described above, in the present embodiment, a plurality of moving devices 85y to 85k corresponding to the plurality of toner cartridges 70k to 70y are disposed in the rotary body 90. The driving device 98 of the apparatus body 1A is a common driving device that drives the plurality of moving devices 85y to 85k (plurality of driven devices) of the rotary body 90.

In addition, in the present embodiment, the driving target of the driving device 98 switches in accordance with the rotation of the rotary body 90. In other words, the driving device of the present embodiment includes the driving racks 15 each serving as a transmission member that transmits the driving force of the drive source. The driving device can take a state in which the transmission member engages with a first driven portion (e.g., pinion gear 94k) in a manner capable of transmitting the driving force and a state in which the transmission member engages with a second driven portion (e.g., pinion gear 94m) in a manner capable of transmitting the driving force. In addition, the driving device can take a state in which the transmission member is disengaged from the first driven portion and the second driven portion.

As described above, the pinion gears 94y to 94k are held by the rotary body 90. Therefore, when the rotary body 90 rotates, it is preferable that the engagement between the driving racks 15 and the pinion gears 94y to 94k is released.

FIG. 11A illustrates a state in which the tray 80k is inside the rotary body 90, that is, a state in which the tray 80k is at the accommodation position. FIG. 11B illustrates a state in which the tray 80k has moved to the outside of the rotary body 90, that is, a state in which the tray 80k has moved to the detachment position.

As illustrated in FIG. 11A, when the tray 80k is inside the rotary body 90, the driving racks 15 are positioned in a lower portion in the apparatus body 1A. At this time, the driving racks 15 are retracted from the pinion gears 94k. Therefore, the rotary body 90 can be rotated without being interrupted by the driving racks 15. More specifically, the driving racks 15 can be retracted to the outside of the rotational trajectory of the rotary body 90 indicated by dotted lines in FIGS. 11A and 11B.

As described above, by rotationally driving the motor M2 in a normal direction and a reverse direction, the tray 80 attached to the rotary body 90 can be moved from the accommodation position to the detachment position and from the detachment position to the accommodation position with respect to the rotary body 90. That is, the driving device of the present embodiment can drive the moving devices such that not only the toner cartridges move from the attached position to the retracted position but also the toner cartridges move from the retracted position to the attached position.

### Color Information of Toner Cartridge

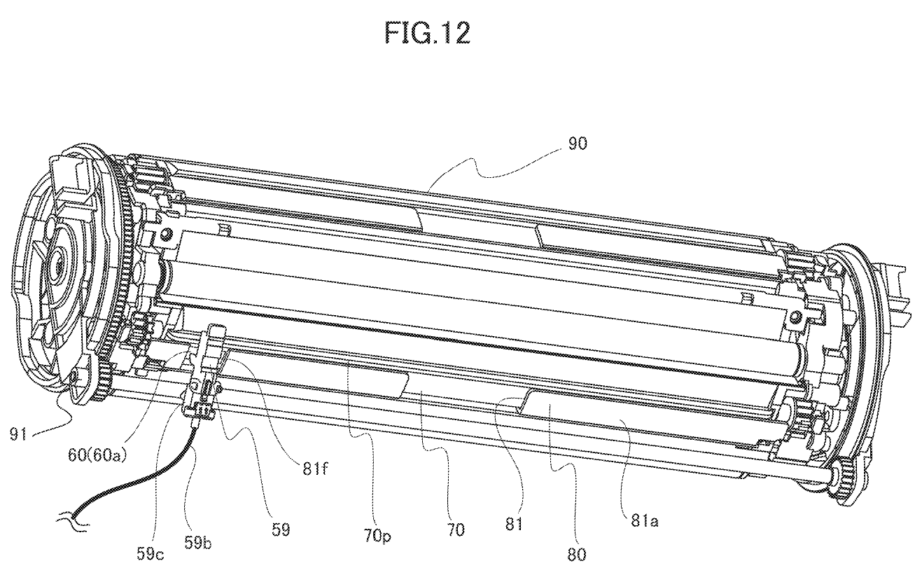

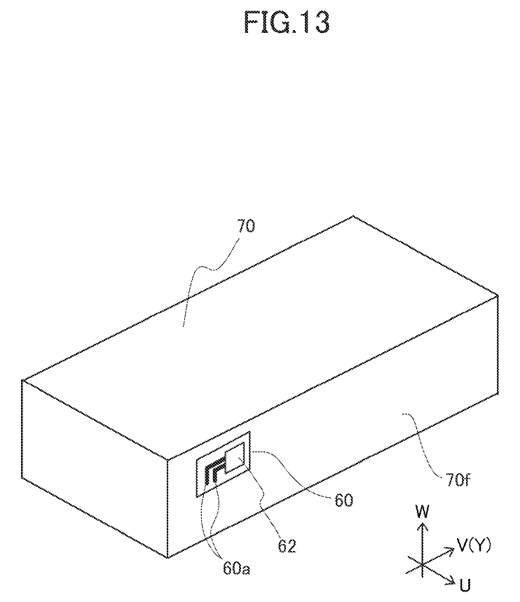

Color information of the toner cartridge 70 according to the present embodiment and elements for reading the color information will be described. FIG. 12 is a perspective view of a color information holding portion 60 (information holding portion) of the toner cartridge 70 and the reading unit 59 (reading portion) of the apparatus body 1A. FIG. 13 is a schematic diagram illustrating the position of the color information holding portion 60 on the toner cartridge 70.

As illustrated in FIG. 12, the color information holding portion 60 serving as an information holding portion that stores information for identifying the type of the toner cartridge 70 is disposed in the toner cartridge 70 according to the present embodiment. In contrast, the reading unit 59 serving as a reading portion for reading information from the color information holding portion 60 is disposed in the apparatus body 1A.

In the present embodiment, the type of the toner cartridge 70 indicates the color of toner stored in the toner cartridge 70. That is, the toner cartridge 70y storing yellow toner, the toner cartridge 70m storing magenta toner, the toner cartridge 70c storing cyan toner, and the toner cartridge 70k storing black toner are toner cartridges 70 of different types from each other.

In addition, in the present embodiment, the “information for identifying the type of the toner cartridge 70” is information (hereinafter referred to as color information) indicating the color of the toner stored in the toner cartridge 70. The color information is data in which a different value is set for each color of yellow, magenta, cyan, and black. That is, the value of the color information stored in the color information holding portion 60 of the toner cartridge 70y, the value of the color information stored in the color information holding portion 60 of the toner cartridge 70m, the value of the color information stored in the color information holding portion 60 of the toner cartridge 70c, and the value of the color information stored in the color information holding portion 60 of the toner cartridge 70k are different from each other.

The color information holding portion 60 of the present embodiment is a circuit board (printed board) on which a storage device 62 (semiconductor storage device, memory chip) storing the color information and a cartridge-side contact 60a (first contact portion) are mounted. The cartridge-side contact 60a is a conductor pattern on the surface of the substrate in the present embodiment, but may be, for example, a lead wire connected to a terminal of the storage device 62. The cartridge-side contact 60a is disposed at a position that can come into contact with the reading unit 59 in a state in which the toner cartridge 70 is attached to the tray 80 and the rotary body 90 is in a reading posture that will be described later. The reading posture is a rotational angle of the rotary body 90 at which the reading unit 59 (reading portion) is allowed to read information from the color information holding portion 60 (information holding portion) of the toner cartridge 70.

As illustrated in FIG. 12, the reading unit 59 includes a body-side contact 59a (FIG. 3D), a wire 59b, and a holder 59c that is formed from resin and that holds end portions of the body-side contact 59a and the wire 59b. One end of the wire 59b is connected to the body-side contact 59a, and the other end of the wire 59b is connected to the controller 30. As a result of the contact between the body-side contact 59a (second contact portion) and the cartridge-side contact 60a (first contact portion), the controller 30 (FIG. 14A) is electrically connected to the color information holding portion 60, and the controller 30 can obtain color information.

The reading unit 59 serving as a reading portion reads the color information by transmitting an electric signal (electric signal conveying color information) input from the storage device 62 via the cartridge-side contact 60a to the controller 30. That is, the reading unit 59 of the present embodiment constitutes a circuit that electrically interconnects the controller 30 that performs control based on the color information obtained from the color information holding portion 60 and the color information holding portion 60 serving as an electric component that holds color information. As will be described later, control based on the color information read from the color information holding portion 60 such as determination of erroneous attachment of the toner cartridge 70 is performed by the controller 30. To be noted, the “reading portion” may be, for example, an integrated circuit (IC) chip that itself accesses the storage device 62 to obtain color information and that transmits the obtained color information to the controller 30.

As illustrated in FIG. 13, the color information holding portion 60 of the present embodiment is disposed on a side surface 70a on one side in a width direction U of the toner cartridge 70. Here, a direction of the longest side of the toner cartridge 70 having an approximate rectangular shape will be referred to as a longitudinal direction V, a long-side direction of the toner cartridge 70 in a cross-section orthogonal to the longitudinal direction V will be referred to as a width direction U, and a direction orthogonal to the longitudinal direction V and the width direction U will be referred to as a height direction W. In the present embodiment, the longitudinal direction V of the toner cartridge 70 attached to the tray 80 is substantially parallel to the rotational axis direction (Y direction) of the rotary body 90. The width direction U of the toner cartridge 70 is substantially parallel to the movement direction Dy, Dm, Dc, or Dk (FIG. 9) of the tray 80 to which the toner cartridge 70 is attached.

The side surface 70a of the toner cartridge 70 on which the color information holding portion 60 is disposed is an upstream end surface of the toner cartridge 70 in the pull-in direction of the tray 80 from the detachment position toward the accommodation position. In addition, the side surface 70a can be referred to as a side surface of the toner cartridge 70 on the outer side in a radius direction of a virtual circle centered on the rotational axis 90C of the rotary body 90 in a state in which the tray 80 has been pulled in to the accommodation position. As a result of disposing the color information holding portion 60 on the side surface 70a, a configuration in which the reading unit 59 disposed on the outer side of the rotary body 90 comes into contact with the cartridge-side contact 60a can be more easily realized than in the case of disposing the color information holding portion on a different side surface of the toner cartridge 70.

As illustrated in FIG. 12, the tray 80 of the present embodiment is provided with a cutout portion (exposing portion) 81f for exposing the cartridge-side contact 60a. The cartridge-side contact 60a is exposed through the cutout portion 81f in a state in which the toner cartridge 70 is attached to the tray 80. In a state in which the rotary body 90 is in the reading posture, the cartridge-side contact 60a opposes the reading unit 59 through the cutout portion 81f, and thus the cartridge-side contact 60a and the body-side contact 59a can come into contact with each other (FIG. 3D).

To be noted, FIG. 12 is merely an example of a configuration for bringing the cartridge-side contact 60a and the body-side contact 59a into contact with each other. The cutout portion 81f does not have to be provided as long as a configuration in which the cartridge-side contact 60a and the body-side contact 59a can come into contact with each other in a state in which the toner cartridge 70 is attached to the tray 80 and the rotary body 90 is in the reading posture that will be described later is employed. Therefore, illustration of the cutout portion 81f is omitted in FIGS. 1 to 11B.

More specifically, the cartridge holding portion 81 of the tray 80 of the present embodiment includes a bottom surface supporting portion 81b that supports the bottom surface of the toner cartridge 70 and a front surface portion 81a that covers at least part of the side surface 70a of the toner cartridge 70 (FIGS. 3A and 12). The bottom surface of the toner cartridge 70 is an end surface of the toner cartridge 70 in the height direction W, and is a surface facing down in the vertical direction in a posture (FIG. 6B) of the toner cartridge 70 in which the toner cartridge 70 is placed on the tray 80. A front surface portion 81a of the tray 80 extends upward from an end portion on the front side (right side in FIG. 3A) of the image forming apparatus 1 in the bottom surface supporting portion 81b in a state in which the rotary body 90 is in the replacement posture. The cutout portion 81f described above is a recess portion that is a portion where part of an upper edge of the front surface portion 81a of the tray 80 is recessed downward. Therefore, in the case where the image forming apparatus 1 is viewed from the front side in a state in which the toner cartridge 70 is placed on the tray 80 positioned at the detachment position, the cartridge-side contact 60a of the color information holding portion 60 is exposed through the cutout portion 81f (FIG. 12).

In the case of not providing the cutout portion 81f, for example, the cartridge-side contact 60a may be disposed on an upper protrusion portion 70p (FIG. 12) of the toner cartridge 70 beyond the tray 80. The upper protrusion portion 70p is a portion where the toner cartridge 70 protrudes more upward than an upper end of the front surface portion 81a in a state in which the toner cartridge 70 is placed on the tray 80.

The reading unit 59 is movable to a position (reading position) where the body-side contact 59a comes into contact with the cartridge-side contact 60a and a position (retracted position) where the reading unit 59 is retracted from the reading position such that the body-side contact 59a is separated from the cartridge-side contact 60a. The retracted position can be referred to as a position where the reading unit 59 is farther from the rotational axis of the rotary body 90 than at the reading position. The actuator Ac1 (FIG. 14A) for moving the reading unit 59 between the reading position and the retracted position is disposed in the apparatus body 1A. The actuator Ac1 may include a drive source such as a motor or a solenoid, and a transmission portion such as a gear that transmits the driving force of the drive source to the reading unit 59.

### Rotational Angle of Rotary

The relationship between the reading posture of the rotary body 90 and the rotational angle and the like of the rotary body 90 at which the toner starts flowing into the developing unit 50 from the toner cartridge 70 will be described with reference to FIGS. 3A to 3E. In the description below, the rotational angle of the rotary body 90 with respect to the yellow replacement posture in the case where the yellow toner cartridge 70y is replaced will be described. However, substantially the same applies to the rotational angle of the rotary body 90 with respect to corresponding replacement postures (magenta, cyan, and black replacement postures) in the cases of replacing the other toner cartridges 70m, 70c, and 70k. In addition, in FIGS. 3A to 3D, the illustration of the toner cartridges 70m, 70c, and 70k other than the toner cartridge 70y will be omitted.

FIG. 3A is a schematic diagram illustrating the rotary body 90 and the toner cartridge 70y immediately after the toner cartridge 70y has been replaced and the tray 80 has been pulled in to the accommodation position. FIG. 3B is a schematic diagram illustrating a state in which the rotary body 90 has been rotated beyond an angle α1 in a normal rotation direction Ra from the state of FIG. 3A. FIG. 3C is a schematic diagram illustrating a state in which the rotary body 90 has been rotated beyond an angle α2 in a reverse rotation direction Rb from the state of FIG. 3A. FIG. 3D is a schematic diagram illustrating the rotary body 90 in the reading posture. FIG. 3E is a schematic diagram illustrating the rotational angles θ of the rotary body 90 to the respective replacement postures and the reading posture with respect to the yellow replacement posture.

In the description below, the rotational angle of the rotary body 90 about the rotational axis 90C with respect to the yellow replacement posture (θ = 0°) will be expressed by θ. In addition, the normal rotation direction Ra is a rotational direction of the rotary body 90 in the image forming operation of forming a color image. A direction opposite to the normal rotation direction Ra will be referred to as a reverse rotation direction Rb. To be noted, in the yellow replacement posture, the direction in which bottom surface of the toner storage portion 71a extends is preferably a direction following the horizontal direction. However, the direction in which the bottom surface of the toner storage portion 71a extends does not have to be parallel to the horizontal direction.

As illustrated in FIG. 3A, in the case where the rotary body 90 is in the yellow replacement posture, the discharge opening 71b of the toner cartridge 70y faces up in the vertical direction (Z direction). That is, the direction from the inside toward the outside of the toner storage portion 71a through the discharge opening 71b is upward in the vertical direction (Z direction). In other words, the direction from the inside toward the outside of the toner storage portion 71a through the discharge opening 71b includes a component in an opposite direction in the gravity direction. Therefore, in the case where the rotary body 90 is in the yellow replacement posture, the toner Tn in the toner storage portion 71a stays in the toner storage portion 71a without being discharged through the discharge opening 71b.

In addition, the developing unit 50 is provided with a non-return shutter that allows flow-in of the toner into the developing-side storage portion 53a through the inlet opening 53b and restricts flow-out of the toner from the developing-side storage portion 53a to the outside through the inlet opening 53b. In the case where the rotary body 90 is in the replacement posture, drop of the toner from the developing-side storage portion 53a is restricted by the non-return shutter.

As illustrated in FIG. 3B, a case where the rotary body 90 is rotated in the normal rotation direction Ra from the yellow replacement posture after the toner cartridge 70y is attached to the tray 80y will be considered. In this case, when the rotational angle θ exceeds the predetermined angle α1, the toner Tn starts flowing into the developing-side storage portion 53a (storage portion) of the developing unit 50 from the toner cartridge 70y attached to the cartridge holding portion 81 (attached portion) of the tray 80y. This is basically the same for a case where, for example, a different toner cartridge 70m or 70c is attached to the tray 80y.

As illustrated in FIG. 3C, a case where the rotary body 90 is rotated in the reverse rotation direction Rb from the yellow replacement posture after one of the toner cartridges 70 is attached to the tray 80y will be considered. In this case, the toner Tn starts flowing into the developing-side storage portion 53a (storage portion) of the developing unit 50 from the toner cartridge 70 attached to the cartridge holding portion 81 (attached portion) of the tray 80y when a rotational angle θ’ in the reverse rotation direction Rb exceeds the predetermined angle α2. This is basically the same for the case where a different toner cartridge 70m or 70c is attached to the tray 80y.

The angles α1 and α2 may be also referred to as angles where the discharge of the toner Tn from the discharge opening 71b is started in the case where the toner cartridge 70 is tilted about the axis in the longitudinal direction V from the posture of the toner cartridge 70 in which the toner cartridge 70 is attached to the tray 80. The angles α1 and α2 do not have to be equal.

### Angle of Reading Posture

The relationship between the reading posture of the rotary body 90 and the angles α1 and α2 described above will be described. As illustrated in FIGS. 1 and 3D, the reading unit 59 (reading portion) is disposed to oppose the cartridge-side contact 60a in a state in which the rotary body 90 has rotated by a predetermined angle β in the normal rotation direction Ra from the replacement posture. That is, the reading posture of the rotary body 90 in the present embodiment is a position where the rotary body 90 has rotated by the angle β in the normal rotation direction Ra from the replacement posture. The angle β is a rotational angle of the rotary body 90 from the replacement posture to the reading posture in the normal rotation direction Ra.

As described above, in the case where the rotational angle of the rotary body 90 is within a range between the angle α1 in the normal rotation direction Ra and the angle α2 in the reverse rotation direction Rb with respect to the replacement posture, the toner Tn does not flow into the developing-side storage portion 53a from the toner cartridge 70 attached to the cartridge holding portion 81 (attached portion). The reading posture of the rotary body 90 is set to a rotational angle within the range described above.

As illustrated in FIGS. 1 and 3E, in the present embodiment, the angle β is smaller than the angle α1 (β < α1). That is, the rotary body 90 is configured to take the reading posture before the rotational angle of the rotary body 90 exceeds α1 in the case where the rotary body 90 is rotated in the normal rotation direction Ra after the toner cartridge 70 has been replaced.

For example, it is assumed that the toner cartridge 70 is attached to the cartridge holding portion 81y of the tray 80y in a state in which the rotary body 90 is in the yellow replacement posture. When the rotary body 90 rotates in the rotational direction Ra by the angle β smaller than the angle α1 from the yellow replacement posture and takes the reading posture, the color information is read by the reading unit 59. Therefore, the type of the toner cartridge can be identified in a state in which toner has not flowed into the storage portion (developing-side storage portion 53a) provided on the rotary side from the toner cartridge 70 attached to the cartridge holding portion 81y (attached portion) of the tray 80y.

### Reading of Color Information

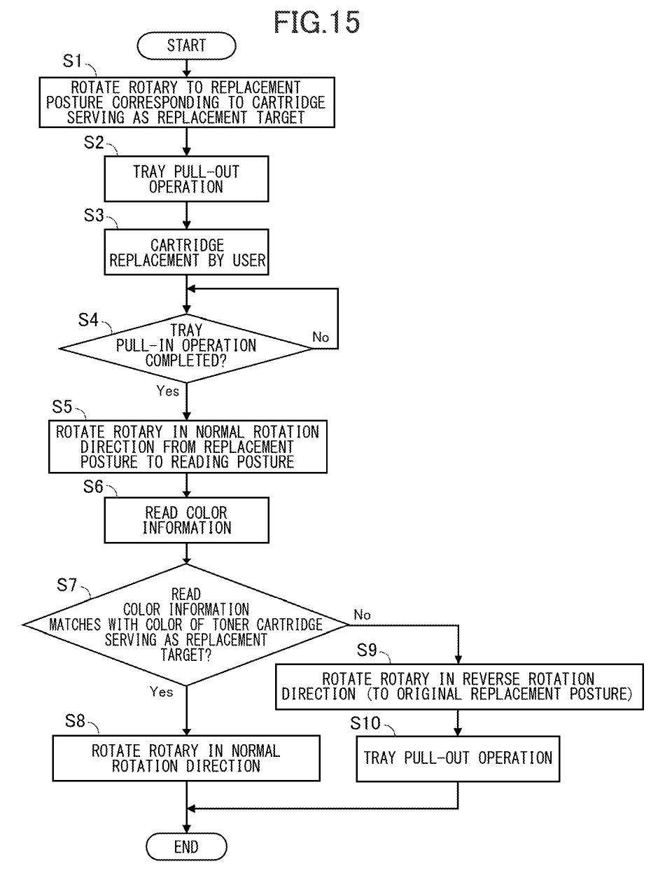

Next, control related to reading of the color information will be described in accordance with a flowchart of FIG. 15. In the description below, it is assumed that each step of the flowchart is executed by the controller 30 (CPU 31) in accordance with a program unless otherwise described. In addition, in the flowchart below, “toner cartridge 70” refers to the toner cartridge 70 newly attached by the replacement performed by the user in step S3.

As described above, when the controller 30 receives an instruction of a toner cartridge replacement operation from the user, the controller 30 rotates the rotary body 90 to a replacement posture corresponding to the toner cartridge 70 serving as a replacement target (S1). When the rotary body 90 reaches the replacement posture, the controller 30 executes a tray pull-out operation of moving the tray 80 supporting the toner cartridge 70 serving as a replacement target from the accommodation position to the detachment position (attachment/detachment position) (S2). When the tray 80 is pulled out to the detachment position, the user detaches the toner cartridge 70 serving as a replacement target from the tray 80, and attaches a new toner cartridge 70 to the cartridge holding portion 81 of the tray 80 (S3). Then, the controller 30 executes a tray pull-in operation of moving the tray 80 from the detachment position to the accommodation position on the basis of an instruction from the user.

A tray pull-in sensor 57 (FIG. 14A) is disposed to be capable of detecting a moving member (for example, the driving rack 15) in a driving device at a predetermined position. The controller 30 determines whether or not the tray pull-in operation has been completed on the basis of a detection result of the tray pull-in sensor 57 (S4). When the tray pull-in operation is completed (S4: Yes), the controller 30 rotates the rotary body 90 by the angle β from the replacement posture (FIG. 3A) to the reading posture (FIG. 3D) in the normal rotation direction Ra, and stops the rotary body 90 at the reading posture (S5).

As a result of the rotary body 90 taking the reading posture, the color information holding portion 60 faces the reading unit 59. In addition, the controller 30 positions the reading unit 59 at the retracted position before the rotary body 90 takes the reading posture, and moves the reading unit 59 to the reading position in a state in which the rotary body 90 is in the reading posture. As a result of this, the body-side contact 59a comes into contact with the cartridge-side contact 60a, and the color information holding portion 60 is electrically connected to the controller 30 via the reading unit 59.

The controller 30 reads the color information of the toner cartridge 70 from the color information holding portion 60 (S6). When reading of the color information is finished, the controller 30 retracts the reading unit 59 from the reading position to the retracted position.

In the case where the color information read in S6 matches the color of the toner cartridge 70 serving as a replacement target (color of the toner cartridge 70 for which an instruction of replacement operation has been received from the user) (S7: Yes), the controller 30 determines that a correct type of toner cartridge 70 has been attached. In this case, the controller 30 resumes the rotation of the rotary body 90, and allows the rotary body 90 to rotate in the normal rotation direction Ra beyond the angle α1 (S8). That is, the controller 30 allows toner to flow into the developing-side storage portion 53a from the toner cartridge 70. To be noted, in the case where there is an instruction to perform the replacement operation for another toner cartridge 70, the controller 30 rotates the rotary body 90 to a next replacement posture corresponding thereto.

In contrast, in the case where the color information read in S6 does not match the color of the toner cartridge 70 serving as a replacement target (S7: No), the controller 30 determines that a correct type of toner cartridge 70 is not attached. In this case, the controller 30 rotates the rotary body 90 in the reverse rotation direction Rb to the original replacement posture (S9). That is, the controller 30 restricts rotation of the rotary body 90 beyond the angle α1. As a result of this, flow-in of the toner from the toner cartridge 70 into the developing-side storage portion 53a can be suppressed.

In addition, the controller 30 executes the tray pull-out operation again in a state in which the rotary body 90 has returned to the original replacement posture (S10). Together with the tray pull-out operation, the controller 30 may notify the user of information indicating that a wrong type of toner cartridge 70 is attached to the tray 80 by, for example, screen display on the operation panel. To be noted, the controller 30 may notify the user of the information indicating that a wrong type of toner cartridge 70 is attached to the tray 80 by, for example, screen display on the operation panel in a state in which the rotary body 90 has returned to the original replacement posture. Then, the controller 30 may execute the tray pull-out operation in response to an instruction of the tray pull-out operation from the user.

### Summary of Present Embodiment

As described above, in the present embodiment, one of a plurality of toner cartridges 70 storing toners of different types from each other is attached to the attached portion of the rotary body 90 (rotary). Further, a configuration in which the toner starts flowing into the storage portion from the toner cartridge 70 attached to the attached portion when the rotational angle of the rotary body 90 from the replacement posture exceeds the predetermined angle α1 is employed. Here, the replacement posture is, for example, the yellow replacement posture, the attached portion is the cartridge holding portion 81y of the tray 80y, and the storage portion is, for example, the developing-side storage portion 53a of the developing unit 50y.

In other words, the rotational angle of the rotary from the replacement posture in the case where the rotary is rotated in a predetermined direction (Ra) from the replacement posture after one of the plurality of toner cartridges 70 is attached to the attached portion will be denoted by θ. In this case, the rotary of the present embodiment is configured such that toner does not flow into the storage portion from the toner cartridge attached to the attached portion in a state in which the rotational angle θ is equal to or smaller than the first angle (α1). In addition, the rotary of the present embodiment is configured such that toner flows into the storage portion from the toner cartridge attached to the attached portion in a state in which the rotational angle θ is larger than the first angle (α1).

Further, the reading unit 59 (reading portion) is configured to read information from the color information holding portion 60 in a state (reading state) in which the rotary body 90 has been rotated in the normal rotation direction Ra to the angle β smaller than the angle α1. In other words, the reading portion is configured to read information from the information holding portion in a state in which the rotary has been rotated in a predetermined direction to a second angle smaller than the first angle.

Further in other words, the discharge opening faces up in the vertical direction when the toner cartridge is attached to the attached portion of the rotary in the replacement posture. Further, toner starts flowing into the developing-side storage portion from the toner cartridge when the rotary is rotated in the predetermined direction from the replacement posture beyond the first angle. The reading portion is configured to read information from the information holding portion before the rotary is rotated beyond the first angle in the predetermined direction from the replacement posture in the case where the toner cartridge is replaced.

A state in which the rotary body 90 has rotated in the normal rotation direction Ra by the angle α1 from the replacement posture can be referred to as a state in which the rotary body 90 is in a flow-in start posture. The flow-in start posture of the rotary body 90 is a posture in which flow-in of toner from the toner cartridge 70 into the storage portion is started. When the rotary body 90 is in the flow-in start posture, it can be said that the toner cartridge 70 is positioned at a flow-in start position (position where flow-in of the toner from the toner cartridge 70 into the storage portion is started). When the toner cartridge is attached to the attached portion of the rotary body 90 in the replacement posture, the reading unit 59 reads information from the color information holding portion 60 before the rotary body 90 takes the flow-in start posture for the first time. For example, in the present embodiment, after the rotary body 90 has rotated in the normal rotation direction Ra from the replacement posture and the reading unit 59 has read the information from the color information holding portion 60, the rotary body 90 rotates in the normal rotation direction Ra and takes the flow-in start posture.

As a result of this, even in the case where a wrong type of toner cartridge is attached to the attached portion, the color information can be read from the toner cartridge 70 in a state before the rotational angle of the rotary exceeds the angle α1. For example, even in the case where a wrong type of the toner cartridge 70 is attached to the cartridge holding portion 81y to which the yellow toner cartridge 70y is supposed to be attached, the color information is read before the rotational angle in the normal rotation direction Ra from the yellow replacement posture exceeds the angle α1.

As described above, according to the present embodiment, an image forming apparatus having a configuration capable of identifying the type of the toner cartridge in a state in which toner has not flowed into the rotary-side storage portion from the toner cartridge attached to the attached portion can be provided.

In addition, in the present embodiment, in a state in which the rotary body 90 has rotated by about 90° in the normal rotation direction Ra from the replacement posture, the opening direction of the inlet opening 53b of the developing-side storage portion 53a is horizontal. The opening direction is a direction orthogonal to the outer surface of the developing frame 53 around the inlet opening 53b and a direction from the inside to the outside of the developing-side storage portion through the inlet opening 53b. In other words, the opening direction of the inlet opening becomes horizontal in the case where the rotary has rotated to the first angle in the predetermined direction from the replacement posture.

Further, the reading unit 59 (reading portion) is configured to read information from the color information holding portion 60 in a state (reading posture) in which the rotary body 90 has rotated to the angle β smaller than 90° in the normal rotation direction Ra from the replacement posture. In other words, the reading portion is configured to read the information from the information holding portion in a state in which the rotary has been rotated to a second angle smaller than the first angle in the predetermined direction from the replacement posture.

Further, in other words, the discharge opening faces up in the vertical direction when the rotary takes the replacement posture. The developing-side storage portion has an inlet opening for receiving toner from the toner cartridge, and the opening direction of the inlet opening becomes horizontal in the case where the rotary is rotated to the first angle in the predetermined direction from the replacement posture. In addition, it can be said that the reading portion is configured to, in the case where the toner cartridge is replaced, read information from the information holding portion before the rotary rotates beyond the first angle in the predetermined direction from the replacement posture.

As a result of this, even in the case where a wrong type of toner cartridge is attached to the attached portion, the color information of the toner cartridge 70 can be read at least before the inlet opening 53b faces upward as compared with the horizontal direction. Therefore, for example, as compared with a configuration in which the color information is read after the direction of the inlet opening 53b has become upward as compared with the horizontal direction, a possibility that toner flows into the developing-side storage portion 53a of the developing unit 50y from the wrong type of toner cartridge 70 can be reduced.

As described above, according to the present embodiment, an image forming apparatus having a configuration capable of identifying the type of the toner cartridge in a state in which toner has not flowed into the rotary-side storage portion from the toner cartridge attached to the attached portion can be provided.

To be noted, the angle β that is a rotational angle of the rotary body 90 from the replacement posture to the reading posture is preferably smaller than the angle of repose of the toner stored in the toner cartridge 70. For example, it is assumed that in a state in which the rotary body 90 is in the replacement posture (FIG. 3A), the upper surface (toner surface) of the toner Tn in the toner cartridge 70 is horizontal. In this case, if the angle β is smaller than the angle of repose, the color information can be read before the upper surface (toner top surface) of the toner Tn collapses in the case where the rotary body 90 is rotated in the normal rotation direction Ra from the replacement posture. Therefore, even in the case where a wrong type of toner cartridge is attached to the attached portion, toner is less likely to flow into the developing-side storage portion 53a of the developing unit 50y from the wrong type of toner cartridge 70.

In addition, according to the present embodiment, the rotary body 90 is allowed to rotate beyond the angle α1 in the normal rotation direction Ra only in the case where the color information read from the color information holding portion 60 matches the color of the toner in the toner cartridge 70 serving as a replacement target (S7 and S8 of FIG. 15). Therefore, in the case where a wrong type of toner cartridge is attached to the attached portion, a possibility that a wrong type of toner flow into the developing-side storage portion 53a and mixes with the correct type of toner can be reduced.

In addition, according to the present embodiment, in the case where the color information read from the color information holding portion 60 does not match the color of the toner in the toner cartridge 70 serving as a replacement target, the rotary body 90 is rotated in the reverse rotation direction Rb from the reading posture to the replacement posture (S9 of FIG. 15). As a result of this, the user can easily replace the wrong type of toner cartridge 70 by a correct type of toner cartridge 70. Particularly, in the present embodiment, a tray pull-out operation of pulling out the tray 80 (support member) from the accommodation position to the detachment position is performed after the rotary body 90 is rotated to the replacement posture (S10 of FIG. 15). As a result of this, the operability of the replacement work of the toner cartridge 70 is further improved.

In addition, according to the present embodiment, the reading unit 59 (reading portion) is positioned at the retracted position while the rotary body 90 is rotated. Therefore, a possibility that the reading unit 59 comes into contact with the rotary body 90 to cause breakage of a part can be reduced.

### Modification Example

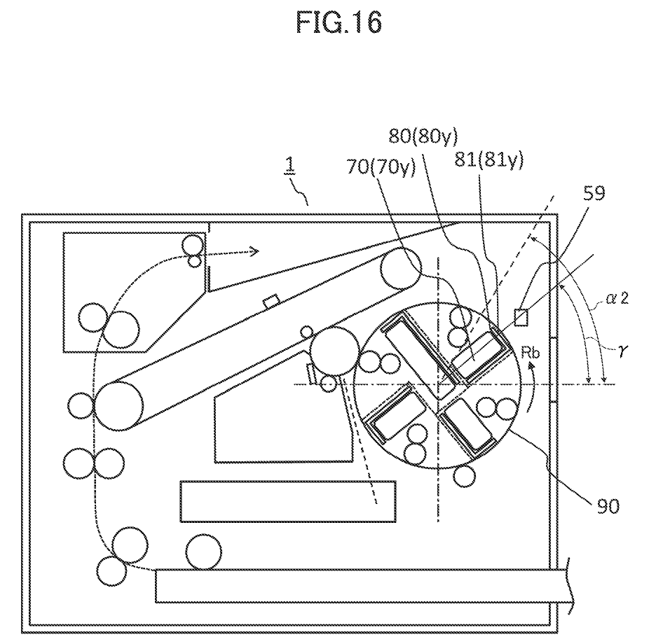

As illustrated in FIG. 16, the reading posture of the rotary body 90 may be a rotational angle to which the rotary body 90 is rotated in the reverse rotation direction Rb from the replacement posture. In this case, an angle γ of the reading posture is preferably smaller than the angle α2 (FIG. 3C) described above (γ < α2).

The control method of the image forming apparatus 1 according to the present modification example is the same as the first embodiment except that the rotary body 90 is rotated in the reverse rotation direction Rb from the replacement posture to the reading posture (see S5 of FIG. 15) in the case where completion of the tray pull-in operation is detected.

In the present modification example, a configuration in which toner starts flowing into the storage portion from the toner cartridge 70 attached to the attached portion, when the rotational angle θ’ of the rotary body 90 in the reverse rotation direction Rb from the replacement posture exceeds the predetermined angle α2. Here, for example, the replacement posture is the yellow replacement posture, the attached portion is the cartridge holding portion 81y of the tray 80y, and the storage portion is the developing-side storage portion 53a of the developing unit 50y.

In other words, the rotational angle of the rotary from the replacement posture in the case where the rotary is rotated in a predetermined direction (Rb) from the replacement posture after one of the plurality of toner cartridges 70 is attached to the attached portion will be denoted by θ’. In this case, the rotary of the present embodiment is configured such that toner does not flow into the storage portion from the toner cartridge attached to the attached portion in a state in which the rotational angle θ’ is equal to or smaller than the first angle (α2). In addition, the rotary of the present embodiment is configured such that toner flows into the storage portion from the toner cartridge attached to the attached portion in a state in which the rotational angle θ’ is larger than the first angle (α2).

Further, the reading unit 59 (reading portion) is configured to read information from the color information holding portion 60 in a state (reading state) in which the rotary body 90 has been rotated in the reverse rotation direction Rb to the angle γ smaller than the angle α2. In other words, the reading portion is configured to read information from the information holding portion in a state in which the rotary has been rotated in a predetermined direction to a second angle smaller than the first angle. In the present embodiment, the rotary rotates in the normal rotation direction Ra after the information is read from the color information holding portion 60. In the case where it is determined that a correct type of toner cartridge 70 is not attached, the controller 30 may perform the tray pull-out operation in the replacement posture or give notification to the user. In the case where the controller 30 has determined that a correct type of toner cartridge 70 is attached, the rotary rotates in the normal rotation direction Ra beyond the replacement posture, and toner flows into the developing-side storage portion 53a of the developing unit 50y from the toner cartridge 70.

A state in which the rotary body 90 has rotated in the normal rotation direction Ra by the angle α1 from the replacement posture and a state in which the rotary body 90 has rotated in the reverse rotation direction Rb by the angle α2 from the replacement posture can be each referred to as a state in which the rotary body 90 is in the flow-in start posture. When the toner cartridge is attached to the attached portion of the rotary body 90 in the replacement posture, the reading unit 59 reads information from the color information holding portion 60 before the rotary body 90 takes the flow-in start posture for the first time. For example, in the present embodiment, after the rotary body 90 has rotated in the reverse rotation direction Rb by the angle γ from the replacement posture and the reading unit 59 has read the information from the color information holding portion 60, the rotary body 90 rotates in the normal rotation direction Ra and takes the flow-in start posture.

As a result of this, similarly to the first embodiment, an image forming apparatus having a configuration capable of identifying the type of the toner cartridge in a state in which toner has not flowed into the rotary-side storage portion from the toner cartridge attached to the attached portion can be provided.

As illustrated in FIG. 3C, the discharge opening 71b is closer to an outer end of the toner storage portion 71a than an inner end of the toner storage portion 71a in the rotational radius direction of the rotary body 90. In addition, as can be understood from FIG. 3C and FIG. 16, in a state in which the rotary body 90 has been rotated to the angle γ in the reverse rotation direction Rb from the replacement posture, the direction in which the weight of the toner acts includes a component that is inward in the rotational radius direction of the rotary body 90. Therefore, the toner is biased toward an end on the far side (inner end of the toner storage portion 71a) from the discharge opening 71b in the rotational radius direction of the rotary body 90, and therefore toner is less likely to flow into the developing-side storage portion 53a of the developing unit 50y from the toner cartridge 70 in the reading posture.

### Second Embodiment

The storage device 62 (semiconductor storage device) has been described as an example of an electric component that carries information (color information) for identifying the type of the toner cartridge 70 in the first embodiment. In a second embodiment, an example in which a resistor element is used as another example of the electric component that carries color information will be described. In the description below, it is assumed that elements denoted by the same reference signs as in the first embodiment basically have the same configurations and functions as those described in the first embodiment unless otherwise described, and part different from the first embodiment will be mainly described.

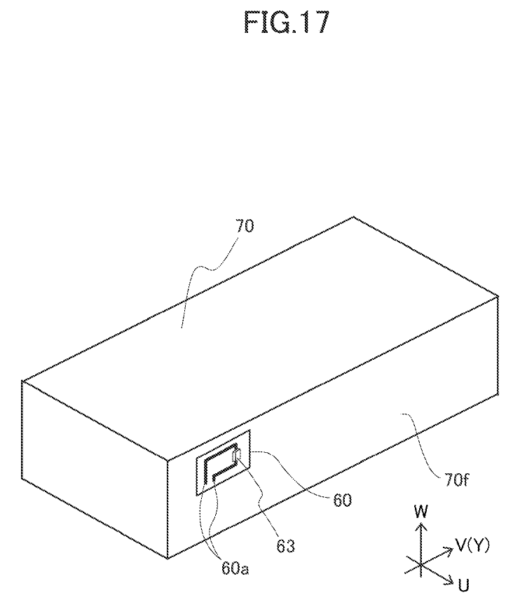

As illustrated in FIG. 17, the color information holding portion 60 of the toner cartridge 70 according to the second embodiment includes a resistor element 63 instead of the storage device 62 described in the first embodiment. The color information holding portion 60 is a circuit board (printed board) on which the resistor element 63 that is a chip resistor and the cartridge-side contact 60a (first contact portion) are mounted. Four types of resistor elements 63 having different resistance values are respectively attached to the four types of toner cartridges 70y, 70m, 70c, and 70k.

When the rotary body 90 is in the reading posture, the body-side contact 59a of the reading unit 59 comes into contact with the cartridge-side contact 60a of the color information holding portion 60, and thus the resistor element 63 is electrically connected to the controller 30. The controller 30 detects the resistance value of the resistor element 63, and thus can obtain the color information of the toner cartridge 70 attached to the cartridge holding portion (attached portion) of the tray 80. The control method of the image forming apparatus 1 according to the present embodiment is substantially the same as in the first embodiment (FIG. 15) except that the controller 30 detects the resistance value of the resistor element 63 instead of accessing the storage device 62 in S6 of FIG. 15.

In the present embodiment, the color information of the toner cartridge 70 is expressed by the resistance value of the resistor element 63. In addition, the reading unit 59 serving as a reading portion reads the color information of the toner cartridge 70 by a method of transmitting a signal (voltage value or current value) corresponding to the resistance value of the resistor element 63 to the controller 30.

To be noted, a lead wire may be used as the resistor element instead of the chip resistor. In this case, for example, the lead wire may be directly fixed to the casing of the toner cartridge 70 instead of through a circuit board, and the lead terminal may be used as the cartridge-side contact 60a.

### Third Embodiment

In a third embodiment, an example in which a capacitor (capacitor element) is used as another example of the electric component that carries color information will be described. In the description below, it is assumed that elements denoted by the same reference signs as in the first embodiment basically have the same configurations and functions as those described in the first embodiment unless otherwise described, and part different from the first embodiment will be mainly described.

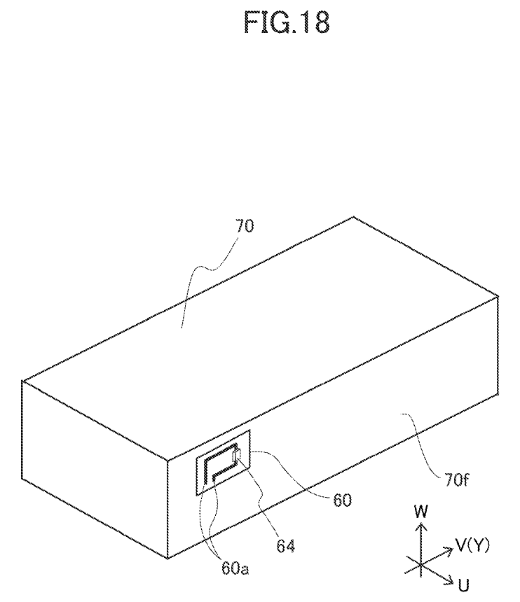

As illustrated in FIG. 18, the color information holding portion 60 of the toner cartridge 70 according to the third embodiment includes a capacitor 64 instead of the storage device 62 described in the first embodiment. The color information holding portion 60 is a circuit board (printed board) on which the capacitor 64 of a chip type and the cartridge-side contact 60a (first contact portion) are mounted. Four types of capacitors 64 having different electrostatic capacities are respectively attached to the four types of toner cartridges 70y, 70m, 70c, and 70k.

When the rotary body 90 is in the reading posture, the body-side contact 59a of the reading unit 59 comes into contact with the cartridge-side contact 60a of the color information holding portion 60, and thus the capacitor 64 is electrically connected to the controller 30. The controller 30 detects the electrostatic capacity of the capacitor 64, and thus can obtain the color information of the toner cartridge 70 attached to the cartridge holding portion (attached portion) of the tray 80. The control method of the image forming apparatus 1 according to the present embodiment is substantially the same as in the first embodiment (FIG. 15) except that the controller 30 detects the electrostatic capacity of the capacitor 64 instead of accessing the storage device 62 in S6 of FIG. 15.

In the present embodiment, the color information of the toner cartridge 70 is expressed by the electrostatic capacity of the capacitor 64. In addition, the reading unit 59 serving as a reading portion reads the color information of the toner cartridge 70 by a method of transmitting a signal (voltage value or current value) corresponding to the electrostatic capacity of the capacitor 64 to the controller 30.

To be noted, a lead-type capacitor may be used as the capacitor 64 instead of the chip-type capacitor. In this case, for example, the lead-type capacitor may be directly fixed to the casing of the toner cartridge 70 instead of through a circuit board, and the lead terminal may be used as the cartridge-side contact 60a.

### Other Modification Examples

In the embodiments described above, description has been given on the premise that toners of different colors are stored in a plurality of toner cartridges 70 and the information for identifying the type of the toner cartridge is color information indicating the color of the toner. The configuration is not limited to this, and for example, toners having different functions or different uses may be stored in the plurality of toner cartridges 70. For example, at least one of the plurality of toner cartridges 70 may store transparent toner for applying gloss to the image or a powder adhesive (adhesive toner) for bonding sheets together. That is, the information for identifying the type of toner cartridge 70 may indicate difference in the function or use of the toner.

In addition, although description has been given on the premise that the plurality of toner cartridges 70 are each provided with a color information holding portion 60 (information holding portion) in each embodiment described above, it suffices as long as the color information holding portion 60 is provided in at least one of the plurality of toner cartridges 70. For example, in the first embodiment, the black toner cartridge 70k larger than the toner cartridges 70y, 70m, and 70c cannot be attached to the trays 80y, 80m, and 80c due to physical restriction. In such a case, the color information holding portion 60 does not have to be provided on the black toner cartridge 70k.

To be noted, the color information holding portion 60 may store information other than the color information (information for identifying the type of the toner cartridge 70). For example, the product number and the lot number of the toner cartridge 70, the amount of toner therein, and the like may be stored in the color information holding portion 60.

In addition, in the embodiments described above, description has been given on the premise that an electric component provided in the color information holding portion 60 carries the color information. The color information holding portion 60 is not limited to this, and may be, for example, a storage medium from which information can be read in a contactless manner such as a radio frequency identification (RFID) tag, or a medium such as a two-dimensional barcode on which information that can be optically read is printed. In the case of using an RFID tag, an RFID reader can be used as the reading portion. In the case of using a two-dimensional barcode, an image sensor such as a complementary metal-oxide semiconductor (CMOS) sensor can be used as the reading portion.

According to the present disclosure, an image forming apparatus having a configuration capable of identifying the type of the toner cartridge in a state in which toner has not flowed into the rotary-side storage portion from the toner cartridge attached to the attached portion can be provided.

### Other Embodiments

Embodiment(s) of the present invention can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-073086, filed April 26, 2024, which is hereby incorporated by reference herein in its entirety.

What is claimed is:

1. An image forming apparatus comprising:
a toner cartridge including a toner storage portion configured to store toner, a discharge opening communicating with the toner storage portion, and an information holding portion;
a rotary including a developing roller, a developing-side storage portion configured to store toner to be supplied to the developing roller, and an attached portion to which the toner cartridge is attached, the rotary being configured to take a replacement posture in which attachment and detachment of the toner cartridge to and from the attached portion are allowed; and
a reading portion configured to read information from the information holding portion,
wherein the discharge opening faces up in a vertical direction when the toner cartridge is attached to the attached portion of the rotary in the replacement posture,
wherein toner starts to flow into the developing-side storage portion from the toner cartridge when the rotary is rotated beyond a first angle in a predetermined direction from the replacement posture, and
wherein in a case where the toner cartridge is attached to the attached portion, the reading portion is configured to read the information from the information holding portion before the rotary is rotated beyond the first angle in the predetermined direction from the replacement posture.

2. An image forming apparatus comprising:
a toner cartridge including a toner storage portion configured to store toner, a discharge opening communicating with the toner storage portion, and an information holding portion;
a rotary including a developing roller, a developing-side storage portion configured to store toner to be supplied to the developing roller, and an attached portion to which the toner cartridge is attached, the rotary being configured to take a replacement posture in which attachment and detachment of the toner cartridge to and from the attached portion are allowed; and
a reading portion configured to read information from the information holding portion,
wherein the discharge opening faces up in a vertical direction when the toner cartridge is attached to the attached portion of the rotary in the replacement posture,
wherein the developing-side storage portion includes an inlet opening to receive toner from the toner cartridge and is configured such that an opening direction of the inlet opening is horizontal in a case where the rotary is rotated to a first angle in a predetermined direction from the replacement posture, and
wherein in a case where the toner cartridge is attached to the attached portion, the reading portion is configured to read the information from the information holding portion before the rotary is rotated beyond the first angle in the predetermined direction from the replacement posture.

3. The image forming apparatus according to claim 1,
wherein the reading portion is configured to read the information from the information holding portion in a state in which the rotary is rotated to a second angle from the replacement posture.

4. The image forming apparatus according to claim 3,
wherein a rotational direction of the rotary in a case where the rotary rotates to the second angle from the replacement posture is opposite to a rotational direction of the rotary in an image forming operation.

5. The image forming apparatus according to claim 3,
wherein the second angle is smaller than an angle of repose of the toner stored in the toner cartridge attached to the attached portion.

6. The image forming apparatus according to claim 1, further comprising:
a drive source configured to rotationally drive the rotary; and
a controller configured to control the drive source and obtain the information via the reading portion,
wherein the controller is configured to:
allow rotation of the rotary in the predetermined direction beyond the first angle in a case where a type of the toner cartridge indicated by the information matches a type of the toner cartridge supposed to be attached to the attached portion; and
restrict the rotation of the rotary in the predetermined direction beyond the first angle in a case where the type of the toner cartridge indicated by the information does not match the type of the toner cartridge supposed to be attached to the attached portion.

7. The image forming apparatus according to claim 6,
wherein the rotary is configured to take the replacement posture in the case where the type of the toner cartridge indicated by the information does not match the type of the toner cartridge supposed to be attached to the attached portion.

8. The image forming apparatus according to claim 7, further comprising:
a body frame configured to accommodate the rotary and provided with an opening,
wherein the rotary includes a support member provided with the attached portion and configured to support the toner cartridge,
wherein the support member is movable between an accommodation position where the toner cartridge attached to the attached portion is accommodated in the body frame and an attachment/detachment position where attachment and detachment of the toner cartridge to and from the attached portion through the opening are allowed, and
wherein in the case where the type of the toner cartridge indicated by the information does not match the type of the toner cartridge supposed to be attached to the attached portion, the controller moves the support member from the accommodation position to the attachment/detachment position in a state in which the rotary is in the replacement posture.

9. The image forming apparatus according to claim 1,
wherein the reading portion is movable between a reading position and a retracted position and configured to be positioned at the retracted position while the rotary is rotated, the reading position being a position where the reading portion is capable of reading the information from the information holding portion, the retracted position being a position where the reading portion is retracted from the reading position.

10. The image forming apparatus according to claim 1,
wherein the discharge opening is closer to an outer end of the toner storage portion than to an inner end of the toner storage portion in a rotational radius direction of the rotary.

11. The image forming apparatus according to claim 1,
wherein in a case where the toner cartridge is a first toner cartridge, the rotary is configured such that the first toner cartridge and a second toner cartridge different from the first toner cartridge are attached to the rotary, and
wherein the first toner cartridge and the second toner cartridge each store toner of a different color.
